(19) United States
(12) Patent Application Publication
(10) Pub. No.: US 2006/0035202 A1
(43) Pub. Date: Feb. 16, 2006

(54) Activity book

(76) Inventors: Christine Ann Broxey, Brooklyn Park, NY (US); Elizabeth Joan Juntune, Woodbury, MN (US)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 11/200,715

(22) Filed: Aug. 10, 2005

Related U.S. Application Data
(60) Provisional application No. 60/600,410, filed on Aug. 10, 2004.

(51) Int. Cl. G09B 5/00

(52) U.S. Cl. 434/317

(57) ABSTRACT

An activity book can help lead people through one or more predefined activities, or provide instructions for interacting with people and enjoying activities together. An activity book can combine humor, light-hearted fun activities, intrigue and mystery, mind challenges and/or introspective conversation. The activity book may be, for example, a lighthearted activity or entertainment book designed to aid people that are attending certain events, places or special occasions. In some cases, the activity books may include hidden surprises.

This application claims priority under 35 USC §119 to U.S. patent application Ser. No. 60/600,410, filed Aug. 10, 2004. This application is expressly incorporated by reference herein, in its entirety.

### TECHNICAL FIELD

The present invention is directed generally to published and electronic materials intended to guide an individual or individuals through a particular event or location.

### BACKGROUND

People meet and interact in a wide variety of situations and circumstances. In some situations, such as exploring a previously un-visited location, a person may not be sure of what to do, or where to go. Sometimes, participating in an event in which the person has no previous experience may be unsettling to the person involved. In some cases, a person may be nervous or unsure of what to do or where to go when meeting someone new, as may occur, for example, on a first date.

A need exists, therefore, for a way to facilitate exploring a new location. A need remains as well for a way to facilitate experiencing a new event, as well as meeting new people.

### SUMMARY

The present invention pertains to a way of facilitating exploring a new location, experiencing a new event, meeting new people, and a myriad of other circumstances in which people meet and interact.

Accordingly, an example embodiment of the present invention is found in an activity book that includes one or more pages that direct a user through one or more predetermined activities, as well as one or more accompaniments that are related to, or will enhance, the one or more predetermined activities. The activity book may be designed for use at a particular location, or with one or more particular destinations. The activity book may be designed for use at a particular event.

The one or more accompaniments may be secured relative to the one or more pages. In some instances, the one or more accompaniments may be disposed within an enclosure that is secured relative to the one or more pages. The enclosure may be an envelope that is held in a closed position by a sticker or a drop or piece of wax. The enclosure may be an envelope that is held in a closed position by a ribbon or by a string.

In some instances, the one or more accompaniments may include items intended to enhance the one or more predetermined activities. If, for example, one of the predetermined activities requires an entrance fee, one of the one or more accompaniments may include a ticket or coupon that satisfies the entrance fee. The one or more accompaniments may have entertainment value, and may, for example, include a poem, a song, or a game. In some instances, the one or more accompaniments may include a device that is configured to, when activated, either play a prerecorded message or else to record a message from the user. The one or more accompaniments may have whimsical value, such as pennies to throw into a wishing well.

In some instances, the one or more predetermined activities may be designed or configured to facilitate a date between two people who are reading the activity book. In some cases, the one or more predetermined activities are designed or configured to facilitate achieving a goal, such as a personal goal or a corporate goal. The one or more predetermined activities may be designed or configured to help someone celebrate an event, such as a holiday or a sponsored event.

In some instances, the activity book may take the form of an electronic device suth as a personal digital assistant (PDA), and thus the one or more pages may include electronic pages. In such cases, the one or more accompaniments may include E-tickets.

In some instances, the one or more predetermined activities are designed to increase a user's knowledge of a particular location, or of a particular event. In some cases, the one or more predetermined activities are designed to increase a user's knowledge of one or more particular destinations.

Another illustrative embodiment of the present invention may be found in a series of activity books that includes at least a first activity book, and a second activity book that is intended for use subsequent to use of the first activity book. The first activity book includes one or more pages directing a user through one or more predetermined activities, and in some cases, includes one or more accompaniments that are related to the one or more predetermined activities. The second activity book also includes one or more pages directing a user through one or more predetermined activities, and in some cases, may include one or more accompaniments that are related to the one or more predetermined activities.

Another illustrative embodiment of the present invention may be found in a fun book that includes a first page bearing instructions to engage in a first activity and a second page bearing instructions to engage in a subsequent second activity. One or more items intended to facilitate the first activity may be secured relative to the first page and one or more items intended to facilitate the second activity may be secured relative to the second page.

Another illustrative embodiment of the present invention may be found in an exploration book that is designed to facilitate exploration of a predetermined location. The exploration book may include a first page bearing instructions to engage in a first activity at a first locale within the predetermined location and a second page bearing instructions to engage in a second activity at a second locale within the predetermined location. One or more items intended to facilitate the first activity may be secured relative to the first page and one or more items intended to facilitate the second activity may be secured relative to the second page.

Another illustrative embodiment of the present invention may be found in an event book that includes a first page bearing instructions to engage in a first activity at the event and a second page bearing instructions to engage in a subsequent second activity at the event. One or more items intended to facilitate the first activity may be secured relative to the first page and one or more items intended to facilitate the second activity may be secured relative to the second page, if desired.

Another illustrative embodiment of the present invention may be found in a date book that is designed for use by two individuals. The date book may include a first page bearing instructions to engage in a first activity and a second page bearing instructions to engage in a subsequent activity. One or more items intended to facilitate the first activity may be secured relative to the first page and one or more items intended to facilitate the subsequent activity may be secured relative to the second page.

Another illustrative embodiment of the present invention may be found in an apparatus that includes a stick and a book secured relative to the stick. The stick may extend outwardly from the book such that the stick forms a handle for the book. In some instances, the book is an activity book that includes two or more pages, wherein at least selected pages lead a user through one or more activities at a particular location.

The above summary of the present invention is not intended to describe each disclosed embodiment or every implementation of the present invention. The Figures, Detailed Description and Examples which follow more particularly exemplify these embodiments.

### BRIEF DESCRIPTION OF THE FIGURES

The invention may be more completely understood in consideration of the following detailed description of various embodiments of the invention in connection with the accompanying drawings, in which:

FIG. 1 is a perspective view of an activity book in accordance with an embodiment of the present invention;

FIG. 2 is a view of an interior of the activity book of FIG. 1, showing two opposing pages;

FIG. 3 is a view of a page of an activity book in accordance with an embodiment of the present invention;

FIG. 4 is a view of the activity book page of FIG. 3;

FIG. 5 is a view of a page of an activity book in accordance with an embodiment of the present invention;

FIG. 6 is a view of a page of an activity book in accordance with an embodiment of the present invention;

FIG. 7 is a view of a page of an activity book in accordance with an embodiment of the present invention;

FIG. 8 is a view of a page of an activity book in accordance with an embodiment of the present invention;

FIG. 9 is a view of a page of an activity book in accordance with an embodiment of the present invention;

FIG. 10 is a view of a series of activity books in accordance with an embodiment of the present invention;

FIG. 11 is a perspective view of an activity book in accordance with an embodiment of the present invention;

FIG. 12 is a view of a page of an activity book in accordance with an embodiment of the present invention;

FIGS. 13-34 illustrate an example activity book in accordance with an embodiment of the present invention; and

FIGS. 35-48 illustrate an example activity book in accordance with an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

The following description should be read with reference to the drawings, in which like elements in different drawings are numbered in like fashion. The drawings, which are not necessarily to scale, depict selected embodiments and are not intended to limit the scope of the invention. Although examples of construction, dimensions, and materials are illustrated for the various elements, those skilled in the art will recognize that many of the examples provided have suitable alternatives that may be utilized.

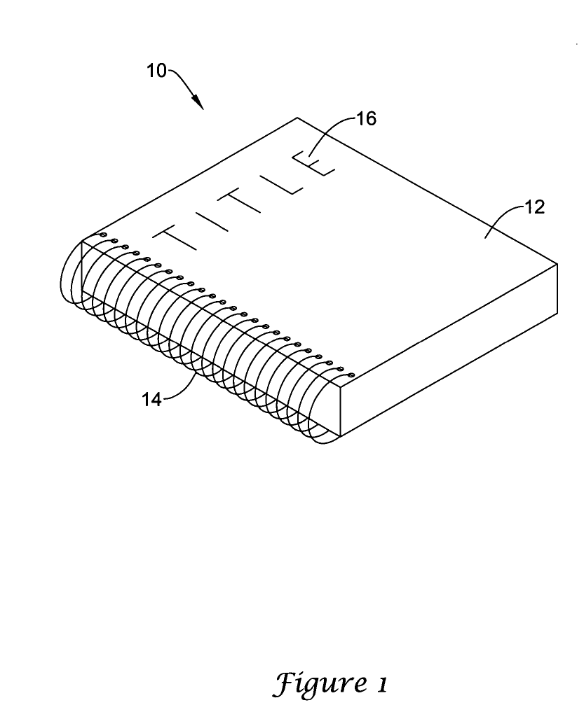

FIG. 1 is a perspective view of an activity book 10. As illustrated, activity book 10 includes a front cover 12 and a spiral binding 14. Activity book 10 may encompass several sheets of paper placed within clear plastic sheet protectors, for example. Activity book 10 may encompass several sheets of paper that are simply stapled or clipped together, or perhaps adhesively secured together. In other instances, it is contemplated that activity book 10 may include other binding forms, as are known in the art.

Front cover 12 may be formed of any suitable material, such as paper, tag board, cardboard, plastic sheets and the like. Activity book 10 may include one or more pages (not illustrated in this view), which similarly are formed of paper, tag board, cardboard, plastic sheets and the like. The content of such pages will be discussed in greater detail hereinafter.

Activity book 10 may include a title 16, which may be used to designate a purpose for activity book 10. Examples of possible titles for activity book 10 include “Date Book”, in which case activity book 10 would be directed to leading two people through a date. Another suitable title 16 would be “Challenge Book”, which may identify a book directed to helping a group of people achieve a common goal. For example, title 16 may be “Eye-Spy Book”, indicating that activity book 10 is directed to challenging one or more users to find hidden answers to riddles or sayings. Title 16 may read “Vision Book”, indicating that activity book 10 is directed to building unity or establishing common vision within a corporate structure. An “Outing Book”, or “Visitor Book”, may indicate that activity book 10 is directed to guiding visitors through one or more locations or events in an unfamiliar city, for example. One of skill in the art will recognize that a myriad of possibilities are encompassed and contemplated by the present invention.

In some instances, activity book 10 may be tailored or themed to a particular holiday, a particular season, a particular event, a particular place, or the like. Examples of suitable holidays to which activity book 10 may be directed include, but are not limited to, New Year's Day, Martin Luther King, Jr. Day, Chinese New Year, Lincoln's Birthday, Presidents'Day, Valentine's Day, Washington's Birthday, Flag Day, St. Patrick's Day, Palm Sunday, Passover, Good Friday, Easter, Labor Day, Mother's Day, Memorial Day, Father's Day, Canada Day, Independence Day, Rosh Hashanah, Yom Kipper, Columbus Day, Thanksgiving, National Boss day, United Nations Day, Halloween, Veterans Day, Thanksgiving, Hanukkah, Christmas, Boxing Day, and Kwanzaa.

In some instances, activity book 10 (and hence title 16) may be directed to a particular event that is not related to a holiday. Examples include, but are not limited to, corporate entertainment, corporate milestones, family reunions, marketing programs or product introductions, events at churches and other religious organizations, events at schools such as universities, colleges, high schools, trade schools, grade schools and the like, anniversaries, birthdays for children, teenagers, young adults, working adults, retirees and/or the elderly.

In some cases, activity book 10 (and hence title 16) may be directed towards use at a particular location. Examples include, but are not limited to, cities and other metropolitan areas such as New York, Chicago, Miami, Minneapolis or Las Vegas, theme parks such as one of the Six Flags™ Theme Parks, Disney World, Disney Land or Camp Snoopy, destination shopping locations such as the Mall of America, and the like.

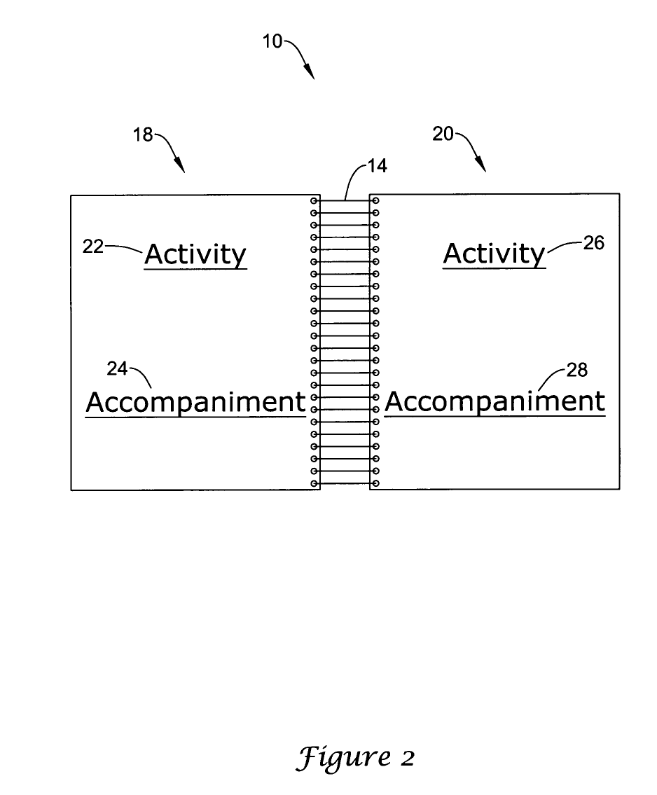

FIG. 2 illustrates an interior of activity book 10. In this Figure, activity book 10 can be seen to include a first page 18 and a second page 20. In this, the designations of first and second are arbitrary, and do not necessarily denote succession. Moreover, it should be noted that first page 18 may represent a back surface of cover 12 (FIG. 1), or may represent a page that is several or even many pages removed from cover 12. Second page 20, as referenced herein, merely refers to a page following first page 18. While not illustrated as such, it is contemplated that there may be intervening pages between first page 18 and second page 20.

First page 18 includes an Activity 22 and an Accompaniment 24. Similarly, second page 20 includes an Activity 26 and an Accompaniment 28. Accompaniment 24 may be an item or items that facilitate Activity 22 while Accompaniment 28 may be an item or items that facilitate Activity 26. It will be appreciated that Activity 22 and Activity 26 may describe or suggest activities that are appropriate with respect to the function of activity book 10, as suggested by Title 16 (FIG. 1).

Activity 22 and Activity 26 may represent text describing an activity, location, event or the like. In some instances, Activity 22 and Activity 26 may include photos, directions, maps and the like. In some instances, one of first page 18 and second page 20 may lack either Accompaniment 24 or Accompaniment 28.

In some instances, Accompaniment 24 and/or Accompaniment 28 may include hidden surprises such as, for example, tickets or coupons, redeemable cards, money, poems, verses, songs, coins, games, fill-in-the-blank notes, funny sayings and/or other fun activities. For example, pre-defined amounts assigned to a coupon or card may provide the user with the ability to embellish the experience of an activity book. Movie tickets, zoo tickets, or any other suitable tickets may also embellish the experience of an activity book. Also, the perceived value of the activity book may be increased with pages that include discounted products or services. For example, discount cards or coupons may be provided for certain stores and/or for certain products in a shopping mall like the Mall of America™ or at a particular event such as a State Fair. In some cases, this may provide a platform for a store and/or manufacturer to introduce a new product or service to the user. Also, and in some cases, a coupon may be embedded for a next purchase discount, which may encourage further purchases and possibly increased profits.

In some instances, first page 18 and second page 20 may include text, images and/or the like. Images may be used to, for example, depict a theme and/or guide the user through the various activities. In some cases, images are selected and/or created to spike interest and grab the attention of the user. These images may be custom designed or stock purchased. Preferably, a variety of images are used. For example, photographs may be used to communicate emotion. It is contemplated that either stock or personal photographs may be used, as desired.

Graphical art may likewise be used. Graphical art may help create interesting text formats and animated imagery. Graphical art may also help emphasize a theme or concept, and/or increase the depth of interest in the activity book. Computer software may be used for original designs or stock graphics may be imported, as desired. Cartoons may also be used. Cartoons may be used to create humor, emit values and/or help tell a story or make a point, as desired. Color may be used to trigger emotions.

Returning to FIG. 2, if Title 16 (FIG. 1) is, for example, “Date Book”, then Activity 22 and/or Activity 26 may be designed to promote opportunities for the two people reading Activity Book 10 to communicate with each other through sharing memories, dreams and/or opinions. Perhaps Activity 22 suggests, for example, that the two people talk about their favorite pet, while Activity 26 prompts the two people to discuss some other facet of their previous life experiences. In such an example, Accompaniment 24 may include pictures of several different pets, or perhaps a map directing the individuals to the local Humane Society. Accompaniment 28 may include a list of conversation starters.

In another example, if Title 16 is “Challenge book”, activity book 10 may be provided to help guide a group of people in achieving a common goal. For instance, a “Challenge book” may be designed for teams of people to compete with each other for a prize or to achieve another pre-determined goal. In one example, “Challenge Books” may be provided to teams of teenagers at a church camp. Each book may have a different objective, and teamwork may be required to complete the objective. For example, team work may be needed to solve a puzzle or identify a moral hidden in the activities, and the first team to complete the objective may win.

An example may be: HONESTY, THE BEST POLICY. Activity 22 (first page 18) of such an illustrative “Challenge Book” may include instructions or clues on the four words that make up the moral, while Accompaniment 24 may be a paper upon which the moral may be written as the individuals figure out what it is. On second page 20, Activity 26 may provide the team with an activity that supports the moral while Accompaniment 28 is absent.

Pages three and four (not shown) may include, respectively, a short skit to be performed that highlights the moral and/or inaccurate quotes to be unscrambled. In this example, each page may take the team in the direction of solving the riddle or unveiling the hidden moral.

In another example, Title 16 may read “Eye-Spy Book”, indicating that activity book 10 may be designed to challenge one or more users to ‘find’ hidden answers to riddles or sayings. The goal in one illustrative Eye-Spy Book may be to find the word or letter that is hidden in each page. Activity 22 (first page 18) may, for example, include a maze or the like that require 3-D glasses to ‘read’ the mystery to solve, while Accompaniment 24 provides the 3-D glasses.

The maze may, for example, outline the ‘game or clues’ that will be given in each of the following pages, including, for example, second page 20. The reader's objective may be to, for example, discover ‘Who Done It’. In one example, the ‘Mystery of the Fly Fisherman’ may be used.

In another example, activity book 10 may be intended as a guide to help entertain out-of-town corporate visitors. Assume, for example, that a group of sales people are coming to town for a corporate sales meeting. A copy of activity book 10 may be provided in each person's hotel room, including perhaps a welcome card from the Vice President of Sales as well as a short letter of appreciation.

On first page 18 (which as discussed need not actually be the first page of activity book 10), Activity 22 may include a suggestion for a wonderful dinner at a local restaurant, while Accompaniment 24 may include, for example, a map to the restaurant in question, or perhaps a coupon good for a free or reduced-cost meal at the restaurant. On second page 20, Activity 26 may include a riddle to be read at dinner while Accompaniment 28 provides an answer to the riddle.

Other pages of activity book 10 (not illustrated here) may include a page that provides historical facts about the city, little known tidbits of information about famous people from the area, etc. Another page may be dedicated to a new product being introduced at the sales meeting. In some cases, activity book 10 may be a unique way to spark conversation, have a good time and learn a little more about the cultural, historical area where the meeting is being held, and/or information about the company and/or new products being offered, as desired.

In another example, activity book 10 may be intended to help or lead out-of-town visitors around a particular town, leading people through a series of one or more particular destinations. An “Outing Book” may resemble a scavenger hunt, and may have pages directing the reader through a sequence of activities—like going to a local festival, park, restaurant, theatres, museums and/or other such places or activities. In some cases, pre-paid advertisements by business owners may enable the reader to receive gifts at restaurants, theatres, museums.

In such an example, Activity 22 (first page 18) may include a suggestion to attend a particular theatre event, while Accompaniment 24 provides directions to the theatre, discount admission to the theatre, or the like. Activity 26 (second page 20) may then include a suggestion for an after-theatre dinner, or after-theatre cocktail while Accompaniment 28 includes a map to the after-theatre location.

In some instances, it is contemplated that activity book 10 may be tailored to the cruise ship industry. For example, many cruise ships have numerous activities planned for the enjoyment of their guests. An “Outing Book” may be provided that directs the reader through a sequence of activities—like going to the swimming pool, a putt-putt golf course, a show, dinner at a particular restaurant, the casino and finally to a particular bar/disco for a night cap.

In another example, a “Welcome Outing Book” may be provided to the guests upon arrival to the ship. The “Welcome Outing Book” may, for example, help familiarize the reader with the ship by guiding the reader through various parts of the ship, possibly providing interesting information about the operation, activities, and/or history of the ship. Muster stations as well as other safety information may also be provided. In some cases, the “Outing Book” may resemble a scavenger hunt to help add fun to the exploration of the ship. Upon completion of the scavenger hunt, the reader may qualify for a drawing to win a prize, for example.

In some cases, a “Visiting Book” may be provided to guests for a particular port of call. For example, a “Visiting Book” may include an introduction to the entertainment and/or sightseeing offerings of the port of call. The Visiting Book may also provide historical facts about the port of call, little known tidbits of information about famous people from the area, maps, etc. The Visiting Book may also provide suggested local restaurants, beaches, car rental companies, excursion companies and locations, etc. In some cases, the “Visiting Book” may outline one or more suggested day trips, which may include a sequence of activities that are designed to allow the reader to get the most out of the often relatively short visit to the port of call. In some cases, the “Visiting Book” may resemble a scavenger hunt, which may help add fun to the exploration of the port-of-call.

Upon completion of the scavenger hunt, the reader may qualify for a drawing to win a prize, for example. The “Outing Books” and/or “Visiting Books” may include coupons, tickets, local currency, and/or any other desired article, if desired, provided as Accompaniment 24 or Accompaniment 28, as appropriate. Such “Outing Books” and/or “Visiting Books” may also be provided to other travelers, such as through travel agencies or airlines for particular destinations.

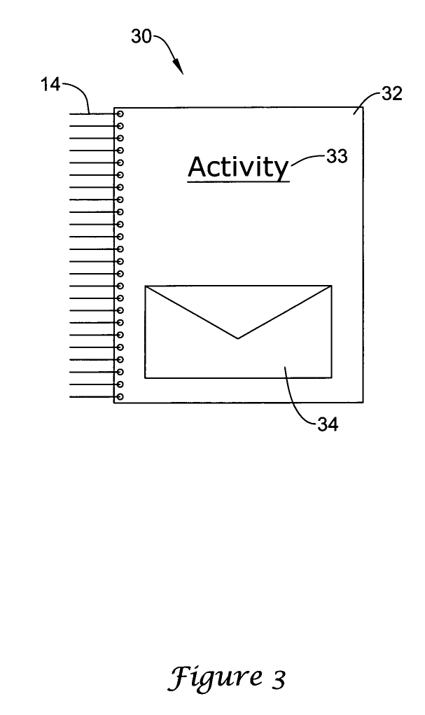

Turning now to FIG. 3, a portion of an activity book 30 is illustrated. In this Figure, activity book 30 has been opened such that a page 32 is visible. Page 32 includes an Activity 33, which as discussed previously with respect to FIG. 1 may include text, photos and the like, suggesting or instructing a reader to engage in a particular activity, visit a particular location, engage in a conversation, or the like. Page 32 also includes an envelope 34, which may be used to hold other components such as envelopes, envelope enclosures, images, interactive devices, coupons, redeemable cards, tickets, money or any other suitable component, as desired.

Envelope 34 may, for example, be a small envelope that can have a variety of colors, textures and sizes, and in some cases, can change color with water, heat or sunlight. In some instances, envelope 34 may be used to hold a ‘surprise’ such as, for example, a poem, a ticket, a coupon, money, a verse, a saying, a quote, a question or any other suitable surprise. When more than one envelope 34 is provided, the surprises in two or more of the envelopes 34 may be related in some way. For example, one envelope 34 may include a key that can be used to unlock another envelope 34. The envelopes 34 may be designed to allow the user to return the ‘surprise’ to the envelope 34 and keep it with the activity book as a keepsake, if desired.

In some embodiments, it is contemplated that the envelopes 34 may hold ‘smart tags’ or the like, which may, for example, trigger a recorded song or message. Also, it is contemplated that some of the envelopes 34 may be stuffed in another envelope, stacked, or arranged in any other suitable manner. In some cases, some of the envelopes 34 may hold blank paper or include a blank region to allow a user to record a response.

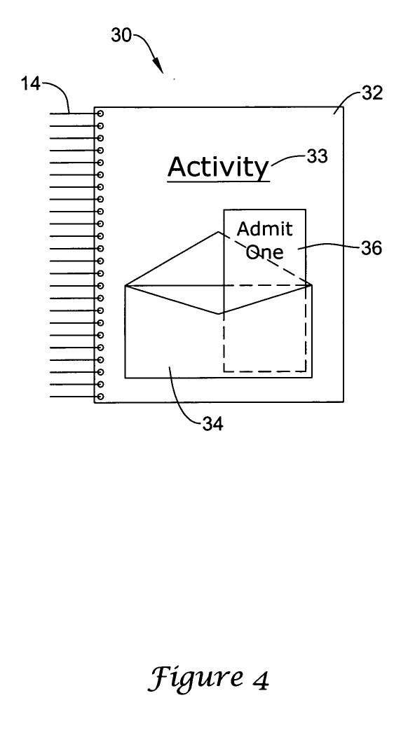

In FIG. 4, envelope 34 has been opened to reveal that envelope 34 included a ticket 36. In some instances, envelope 34 may include an envelope enclosure that may help retain envelope 34 in a closed position and may include a variety of closures. In some instances, it is contemplated that Velcro™ may be used. In some cases, a lock (not shown) may be used to secure envelope 34 in a closed position.

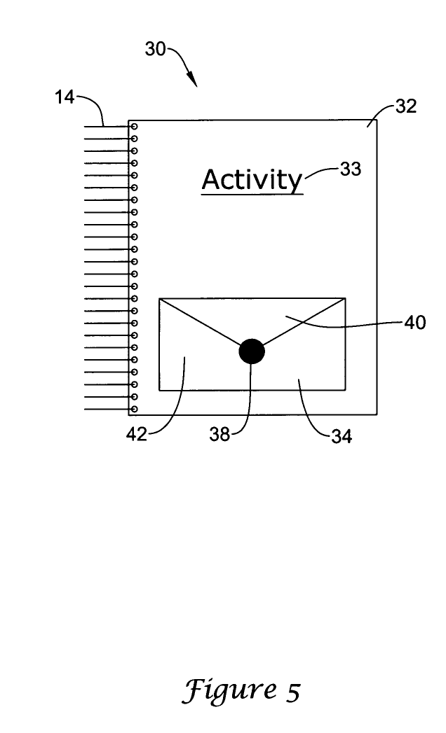

In particular, FIG. 5 illustrates an enclosure 38 that can be a sticker or a dab of wax applied where a flap 40 meets a face 42 of envelope 34. Stickers may have the same theme as activity book 10, and may provide additional art interest. It is contemplated that the stickers may be made of any suitable material including, for example, glossy paper with adhesive or glue. Stamped melted wax may be used to help secure envelope 34 in a closed position. Wax may provide a unique and quaint feel, as well as provide additional interest.

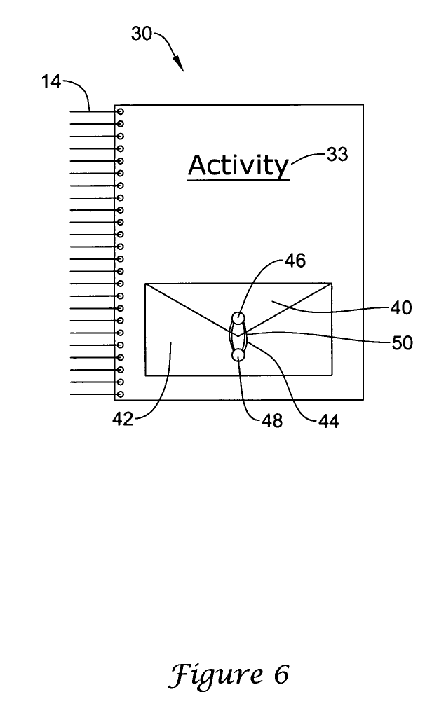

In FIG. 6, an enclosure 44 includes a flap post 46, an envelope post 48 and a string or ribbon 50 wrapped between flap post 46 and envelope post 48. In some instances, flap post 46 and envelop post 48 may include cardboard circles that have been adhesively attached to flap 40 and face 42, respectively.

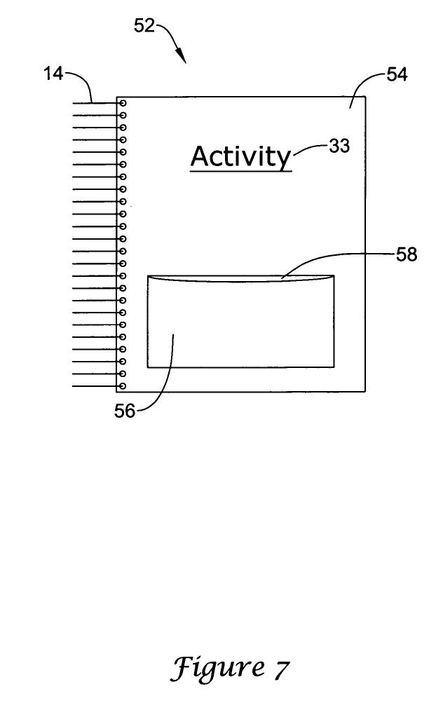

FIG. 7 illustrates a portion of an activity book 52 that includes a page 54. Page 54 includes an Activity 33, as discussed previously, and an enclosure 56 having an open top 58. Any suitable items, such as the Accompaniments discussed previously, may be provided within enclosure 56.

In some instances, activity books may include interactive devices that can provide visual or audio messages to a user. For example, voice or ‘pre-recorded tags’ can be used to incorporate personal sayings, music, a recognized voice; such as, Bob Hope, and may further deepen the impact of the activity books. Enabling a user to pre-select their own message may further personalize an activity book. In some cases, the voice or ‘pre-recorded tags’ may be activated by touching or squeezing the tag, as desired.

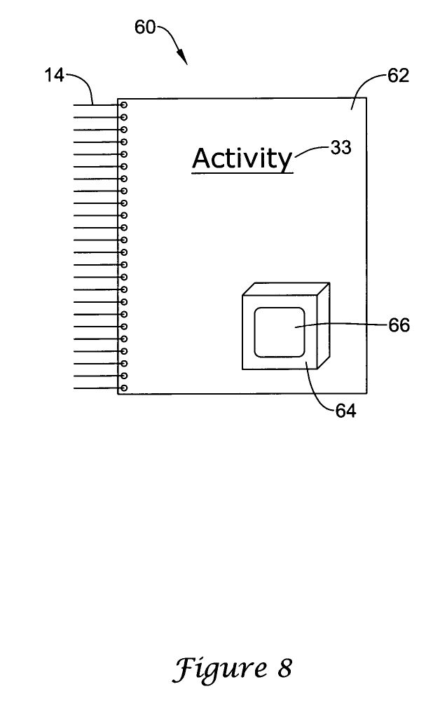

FIG. 8 illustrates a portion of an activity book 60, which has been opened to reveal a page 62. Page 62 can be seen to include a device 64 that has a small screen 66, such as an LCD display, that can be used to display photos, text messages and the like.

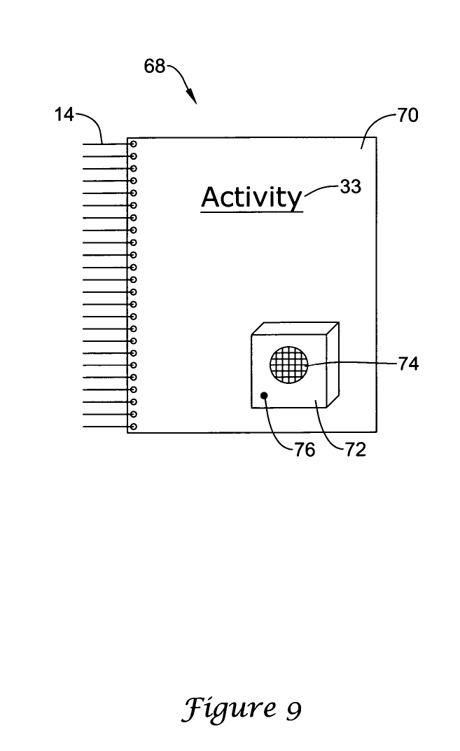

In some instances, it may be desired to provide a user with an ability to record a message for later playback. FIG. 9 illustrates a portion of an activity book 68, which has been opened to reveal a page 70. Page 70 includes a device 72 that includes a speaker 74 that can be used to play audio messages as well as a microphone 76 that can be used by the user to record messages.

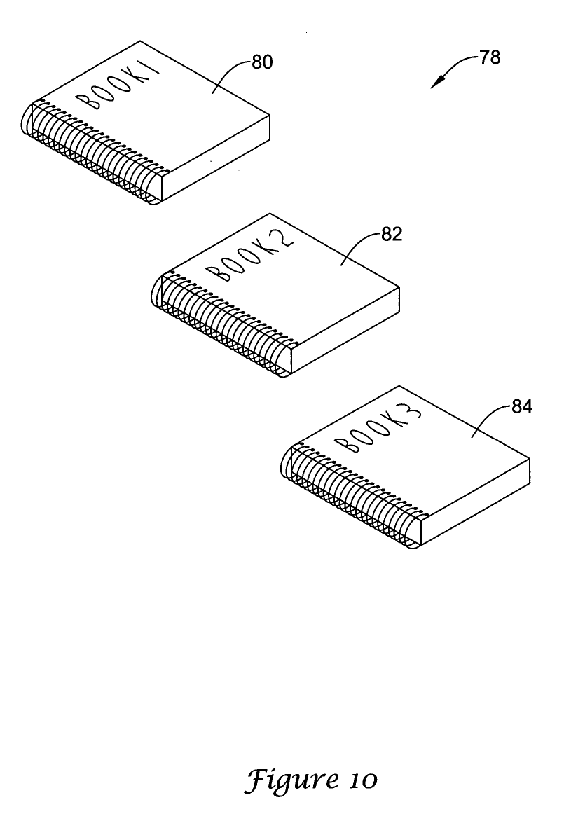

FIG. 10 illustrates a series 78 of activity books including a first series book 80, a second series book 82 and a third series book 84. While three books are illustrated, it should be noted that series 78 may include two, four, five or more books, as desired. Second series book 82 may provide activities that build on activities previously referenced in first series book 80. Similarly, third series book 84 may describe activities that build on activities previously referenced in second series book 82. Moreover, first series book 80 may foreshadow, or hint at, activities in second series book 82 while second series book 82 may foreshadow activities in third series book 84.

In one example, there may be a series of “Date Books”, where the activities in a first “Date Book” may be different from the activities suggested in a second or third “Date Book”. In some cases, the “Series Books” may be provided as monthly or yearly editions, and may be predicated on previous books in the series.

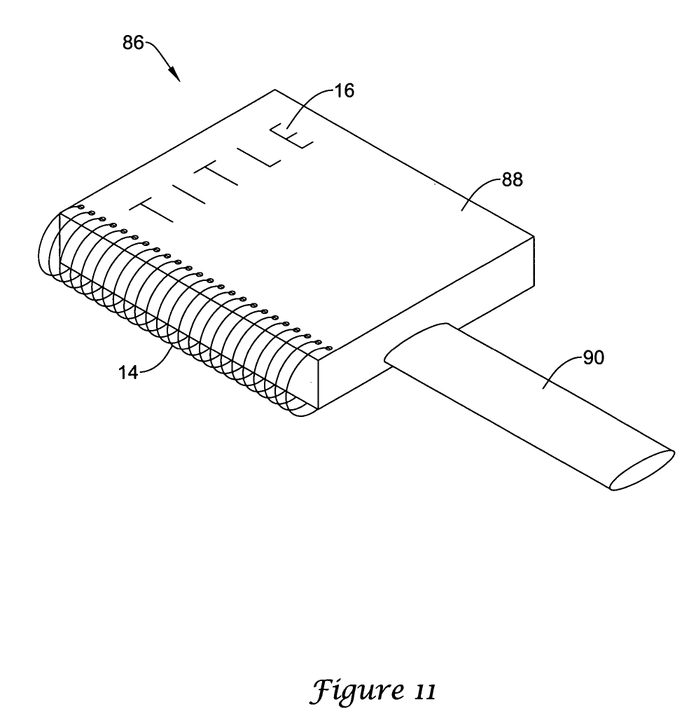

FIG. 11 illustrates an apparatus 86 in which an activity book 88 is seen as secured relative to a stick 90. Stick 90 functions as a handle for activity book 88, and lends additional interest to activity book 88. Stick 90 may be formed from any suitable material, such as suitable stiff cardboard or plastic, or a relatively thin piece of wood. Activity book 88 may be secured relative to stick 90 using any suitable technique, such as gluing activity book 88 to stick 90, or perhaps stapling.

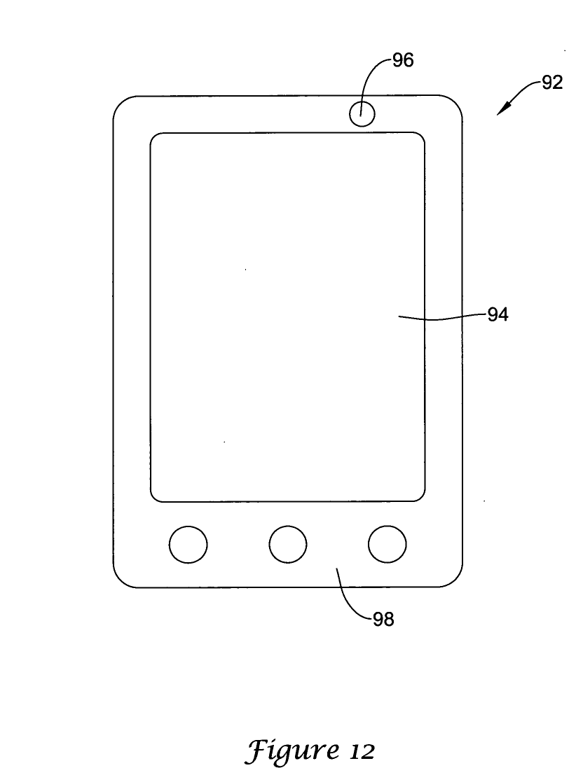

In some instances, an activity book may not include paper at all, but rather may be electronically published. FIG. 12 illustrates a personal digital assistant (PDA) 92 that may be used in realizing an activity book in accordance with the present invention. PDA 92 includes a screen 94 that may be a touch screen, a power button 96 and several additional buttons 98 that may be used for functions not attainable through screen 94. In an electronic activity book, accompaniments that facilitate activities discussed within the electronic activity book may include, for example, E-tickets and the like.

### EXAMPLE A

### “Valentine's Day Date Book” for Mall of America™

The first illustrated example activity book is a “Valentine's Day Date Book” for use at the Mall of America™, which is located in Bloomington, Minn. While the size of the illustrative activity book is based on practical considerations, it contemplated that the activity books may be created in any size. The illustrative activity book is 5¼″×8½″, and is bound by plastic cording on the left side. High grade 44 lb glossy paper was used. The cover is a clear plastic and the back is a heavy ‘leather’ look, although other materials may be used, as desired. A color printer of high quality was used to print the base book designs, which were created on a computer.

Some of the pages are completed with appropriate envelopes and/or ‘surprises’. In the illustrative embodiment, the envelopes are affixed by either glue or corner picture holders. The finished pages have holes punched through to enable the plastic cord to be inserted through the pages to hold the book together. In the illustrative example, movie tickets, coupons for a dessert, ride tickets for Camp Snoopy™, and pennies for tossing into the fountain at Camp Snoopy™ are all included. Each page of the illustrative “Valentine's Day Date Book” will now be described.

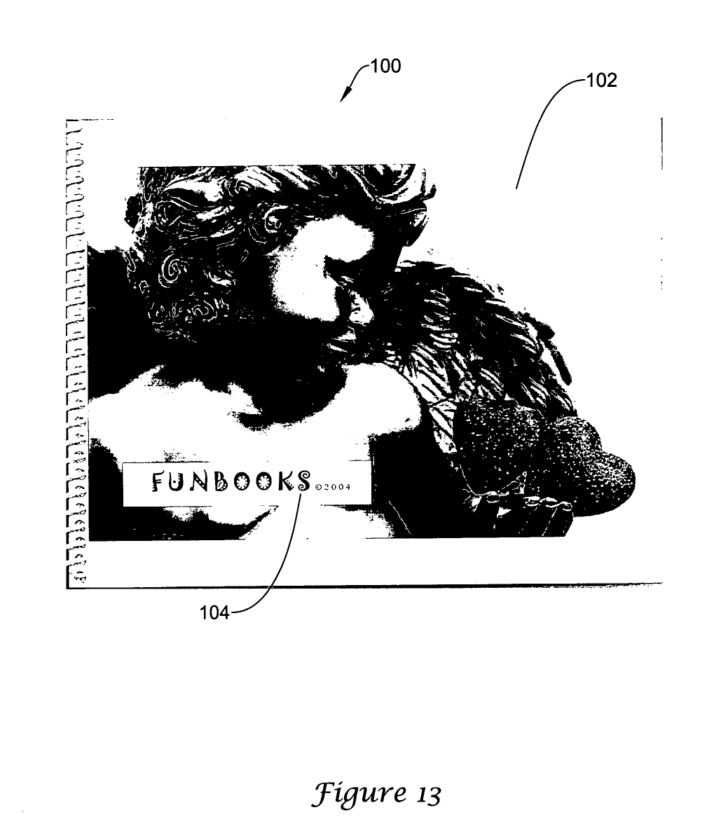

FIG. 13 shows a first page 100 that includes a photo 102 of a bronzed cupid holding two hearts, thereby indicating that this is a Valentine's Day Date Book. First page 100 also includes a text box 104 that includes a name indicating the source of the Valentine's Day Date Book, as well as the publication year.

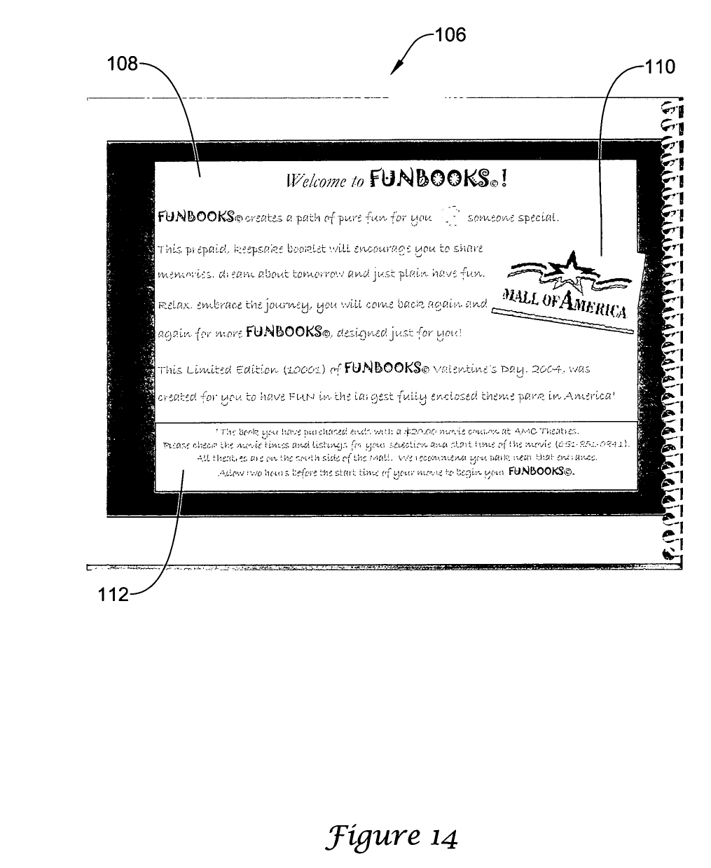

FIG. 14 shows a second page 106 that, in some instances, may represent an opposite side of first page 100. Second page 106 includes a large text box 108 that includes welcoming text. Second page 106 also includes a logo 110, which indicates where this activity book is to be used, as well as an informational text box 112 that includes suggestions to the user regarding movie times and locations. Any suitable colors may be used. In the illustrated example, large text box 108 and informational text box 112 are originally both in white, with dark blue text. Second page 106 has a red color, which is suitable for Valentine's Day.

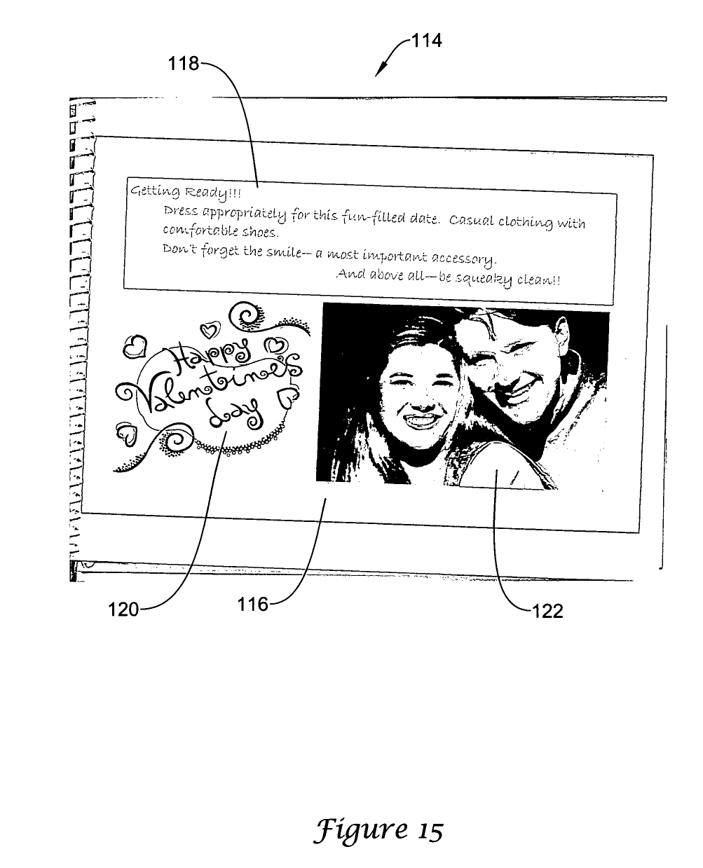

FIG. 15 shows a third page 114 having a red background color. A text box 118 provides appropriate preparatory advice for the two people participating in the Valentine's Day Date Book. Text box 118 has a white background, with dark blue text. A graphic 120 and a photo 122 of a couple remind the users that the intended event is Valentine's Day.

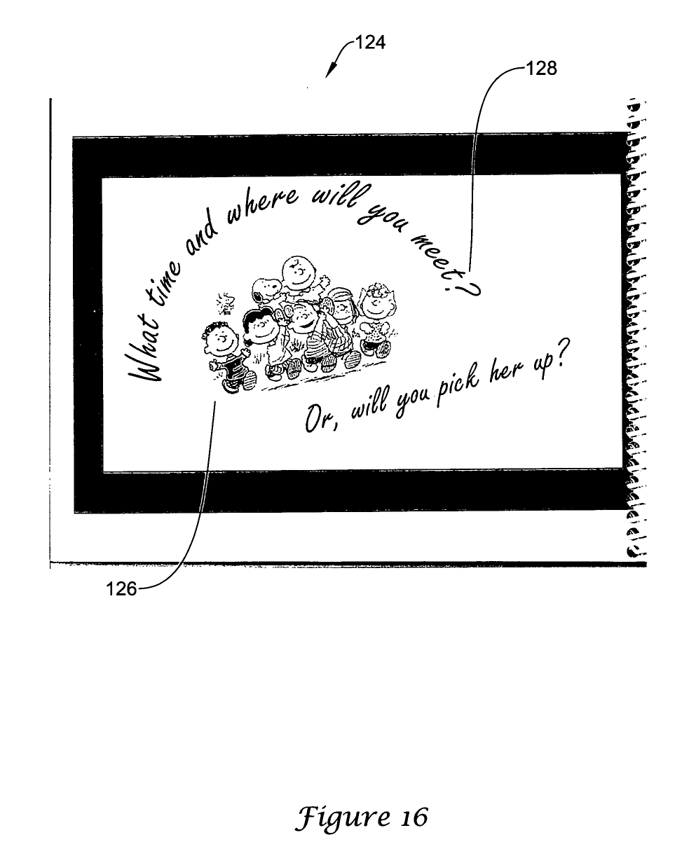

FIG. 16 shows a fourth page 124 that may, in some instances, may represent an opposite side of third page 114. Third page 114 has a yellow or beige background with a dark blue border. A photo 126 of the Snoopy Gang suggests that the individuals participating in the Valentine's Day Date Book may be attending Camp Snoopy™. Text 128 includes a reminder regarding logistics, i.e., is the couple meeting at Camp Snoopy™, or is one participant supposed to pick up the other participant?

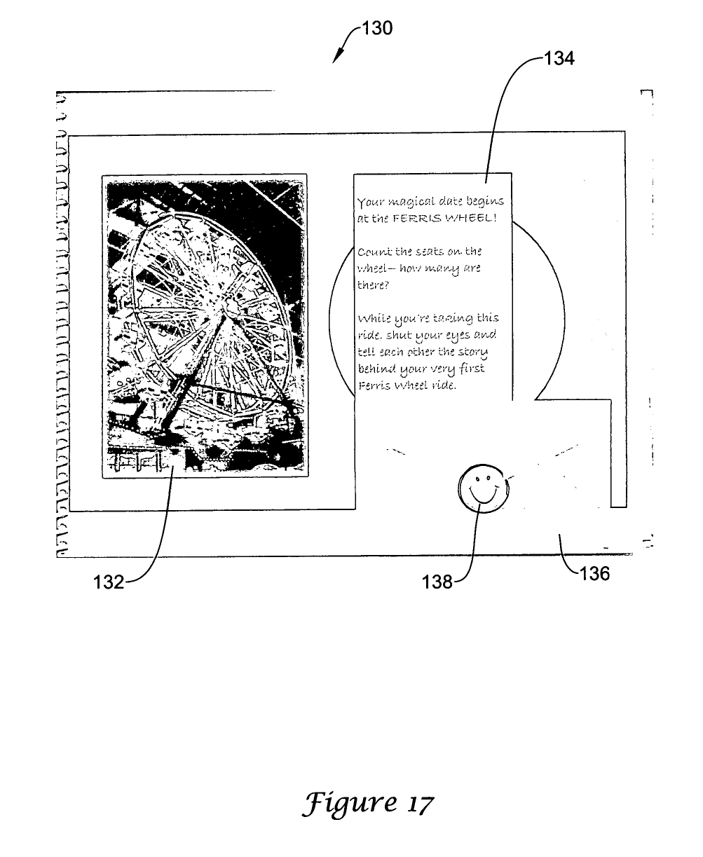

FIG. 17 shows a fifth page 130 also having a yellow or beige background with a dark blue border. A photo 132 of a Ferris Wheel defines a starting point for the date. Text box 134, which is white with blue text, provides instructions intended to spark conversation. An envelope 136, which is sealed with a happy face sticker 138, contains tickets for riding the Ferris Wheel.

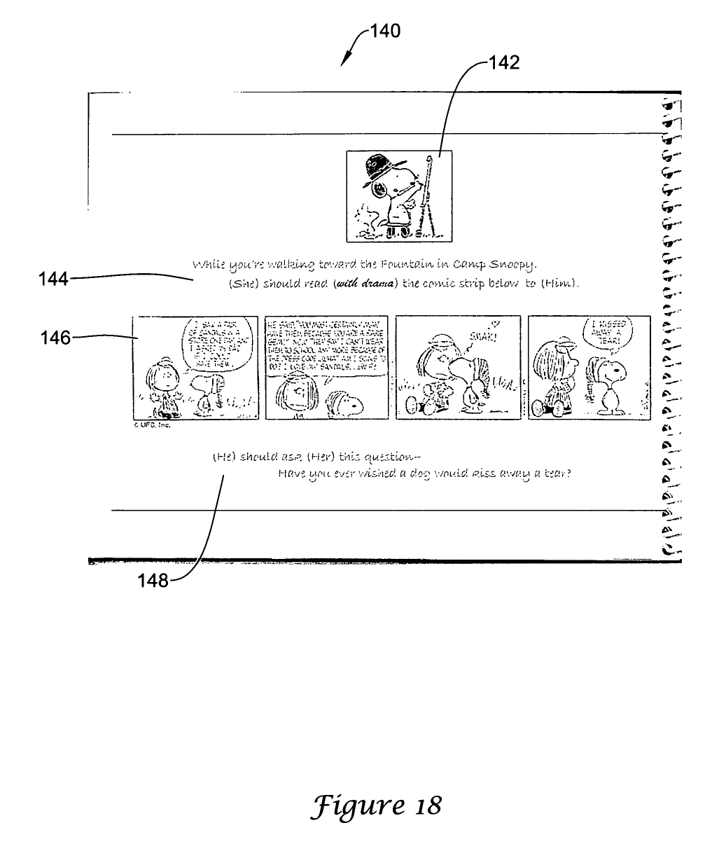

FIG. 18 shows a sixth page 140, which has a tan background, and which may represent an opposite side of fifth page 130. To set the mood, sixth page 140 includes a photo 142 of Snoopy and Woodstock. Sixth page 140 includes elements intended to further the conversation. Text box 144 includes instructions for the female participant to read comic strip 146 to the male participant while walking towards the fountain in Camp Snoopy™. Text box 148 includes instructions for the male participant to ask her a question related to comic strip 146.

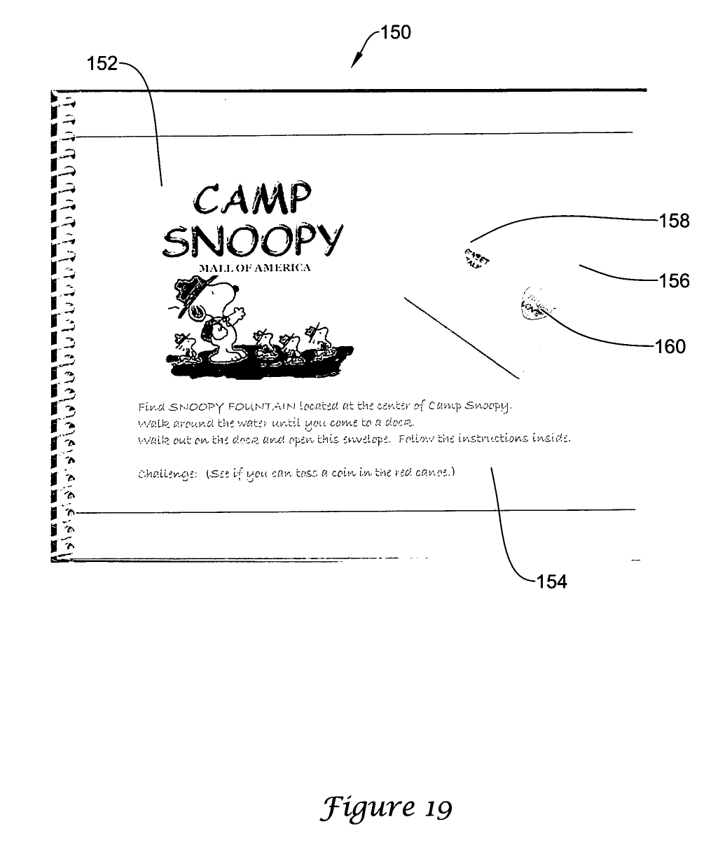

FIG. 19 shows a seventh page 150 having a beige background. Seventh page 150 includes a graphic 152 providing a Camp Snoopy™ logo. A text box 154 having a light background and dark text instructs the date participants to find the Snoopy Fountain, walk out on the dock and open an envelope 156, which is sealed by a first candy heart sticker 158 and a second candy heart sticker 160. For fun, text box 154 includes a challenge to attempt to throw a penny into the red canoe present near the Snoopy Fountain.

Envelope 156 includes several items. Two pennies are included so that each participant can attempt to meet the aforementioned challenge. A small piece of paper providing additional conversation topics is also included in envelope 156. The piece of paper includes statements such as “With this penny, I wish for . . . ”, “With this life, I dream . . . ” and “With this day, I hope that . . . . . . all with you.”

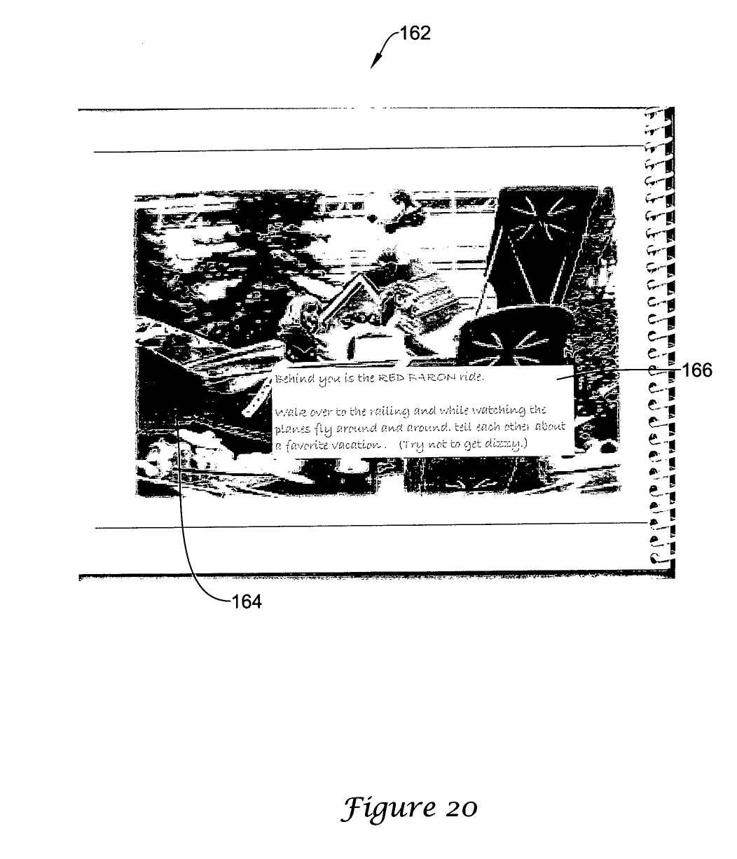

FIG. 20 shows an eighth page 162 that, in some instances, may be considered as the opposite side of seventh page 150. Eighth page 162 has a light blue background and includes a photo 164 of two young girls riding the Red Baron ride and a text box 166 that instructs the date participants to walk over to the railing, watch the planes fly around, and discuss their favorite vacations.

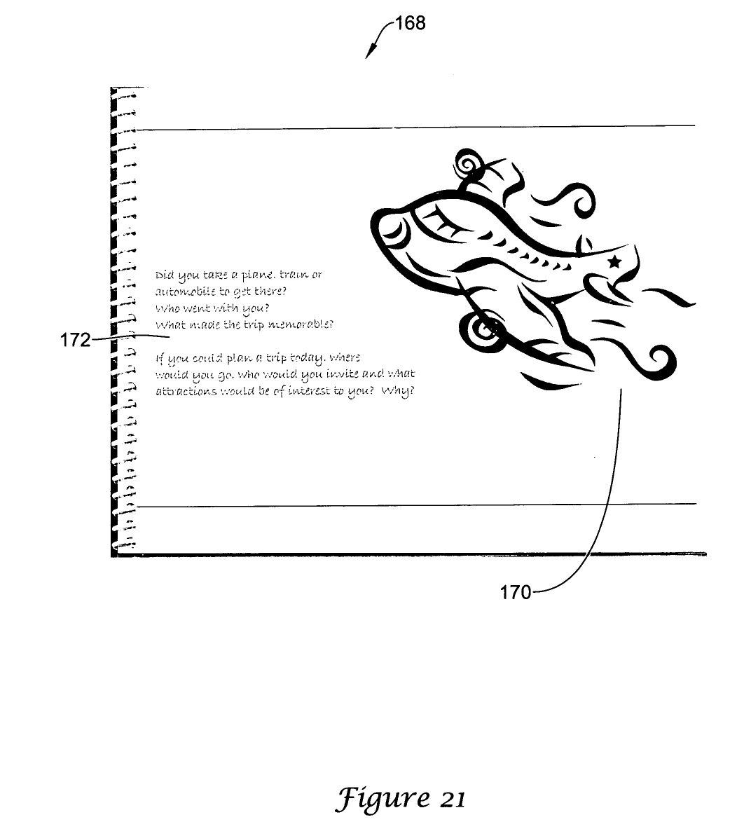

FIG. 21 shows a ninth page 168 having a light blue background. Ninth page 168 includes a graphical cartoon 170 of an airplane, and a text box 172 that, continuing the theme of eighth page 162, provides additional questions concerning vacations. It is thought that the two participants may discuss answers to these questions, and thereby further their conversation.

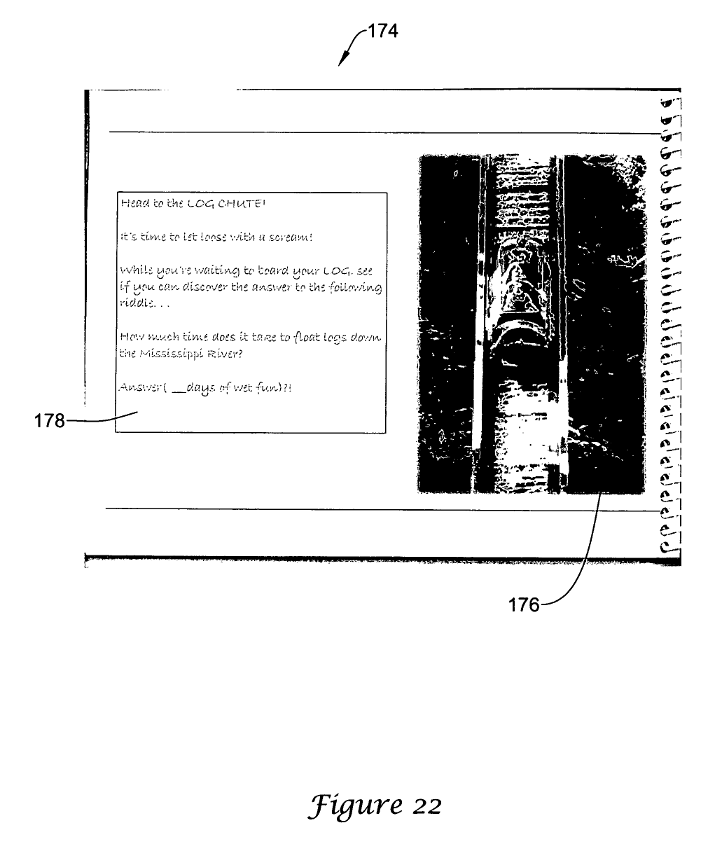

FIG. 22 shows a tenth page 174 that may, in some circumstances, be considered as an opposite side to ninth page 168. Tenth page 174 has a light gray/green background, and includes a photo 178 of the Log Chute ride and a text box 178. Text box 178 includes instructions to proceed to the Log Chute ride, and provides a trivia question to discuss during the walk to the Log Chute ride. While the answer to the trivia question is not provided, it is thought that the question may spark further conversation.

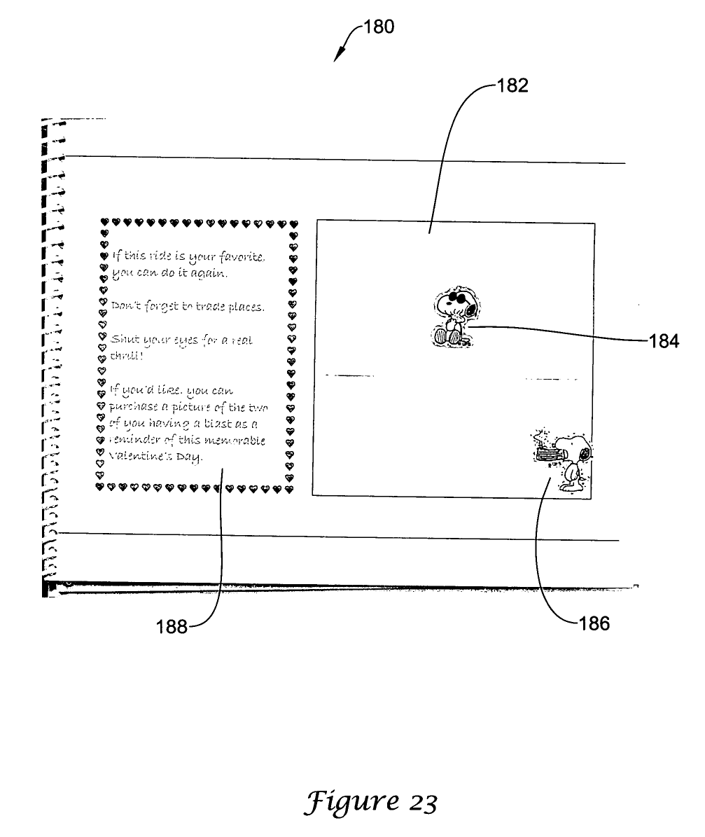

FIG. 23 shows an eleventh page 180 having a light gray/green background. Eleventh page 180 includes an envelope 182 that is sealed shut with a Snoopy sticker 184. Inside envelope 182 are tickets to the Log Chute ride. Eleventh page 180 includes a Snoopy graphic 186 for fun. A text box 188 provides several suggestions for the couple.

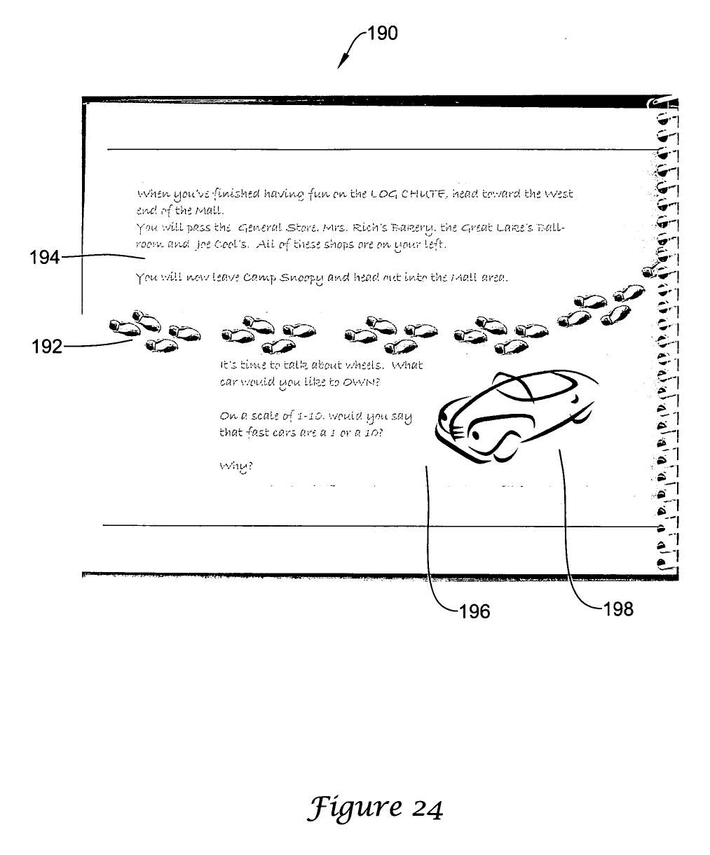

FIG. 24 shows a twelfth page 190 having a sky blue background. Twelfth page 190 may be considered as an opposite side to eleventh page 180. Twelfth page 190 includes a graphic 192 of footsteps, which is intended to indicate that the user will be walking out of Camp Snoopy™. Text box 194 includes instructions as to where the user should walk to. A text box 196 and an accompanying graphic 198 introduces another discussion topic.

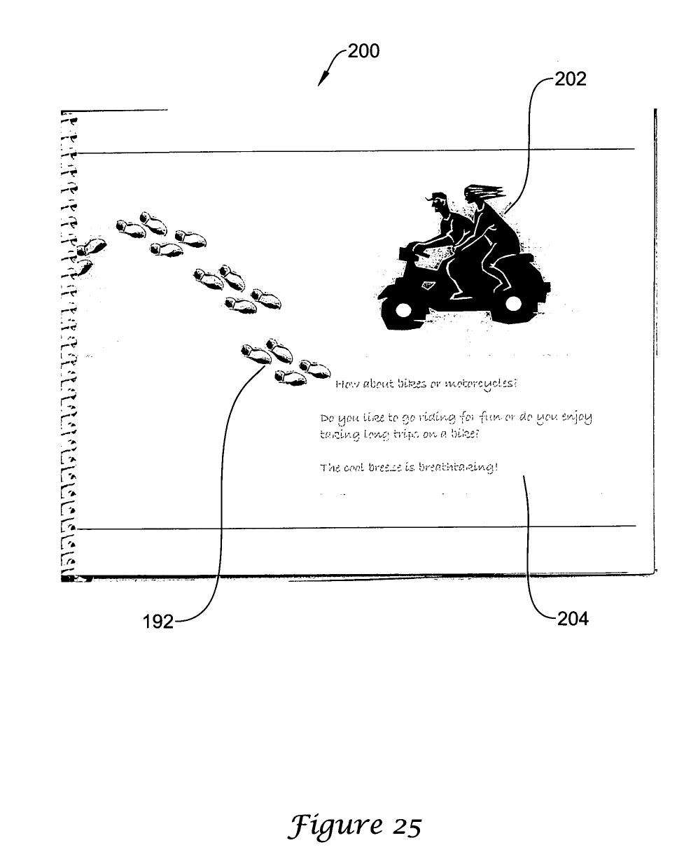

FIG. 25 shows a thirteenth page 200 having a sky blue background. The footsteps graphic 192 of FIG. 24 continues onto thirteenth page 200. A graphic 202 of a motorcycle and text box 204 introduces another discussion topic.

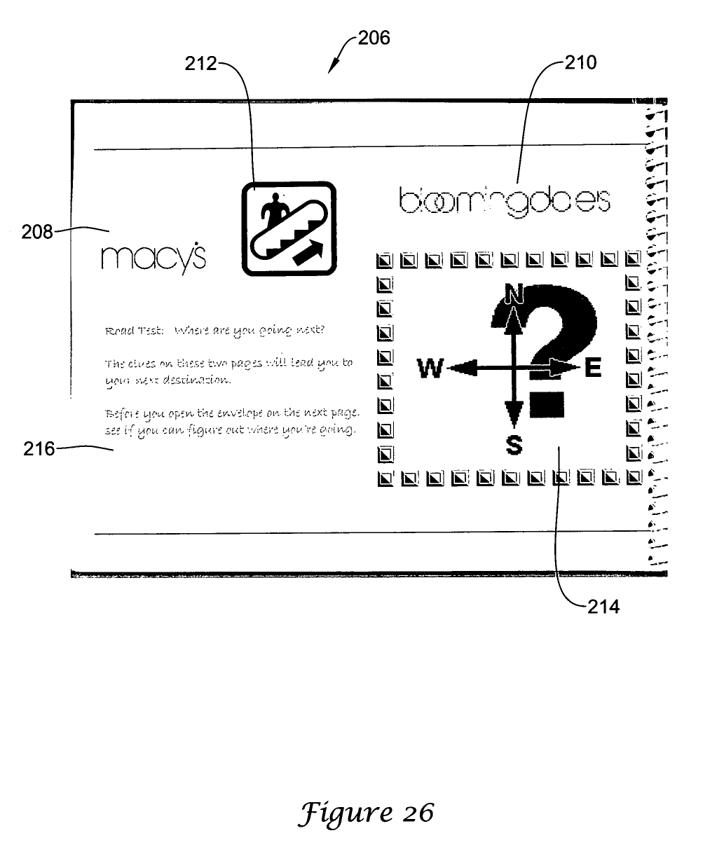

FIG. 26 shows a fourteenth page 206 having a pink background. Fourteenth page 206, which may be considered as an opposite side to thirteenth page 200, includes a Macy's™ logo 208 and a Bloomingdales™ log 210, along with a graphic 212 of an escalator and a graphic 214 of a compass. A text box 216 suggests that the upcoming pages will provide clues as to the user's next destination.

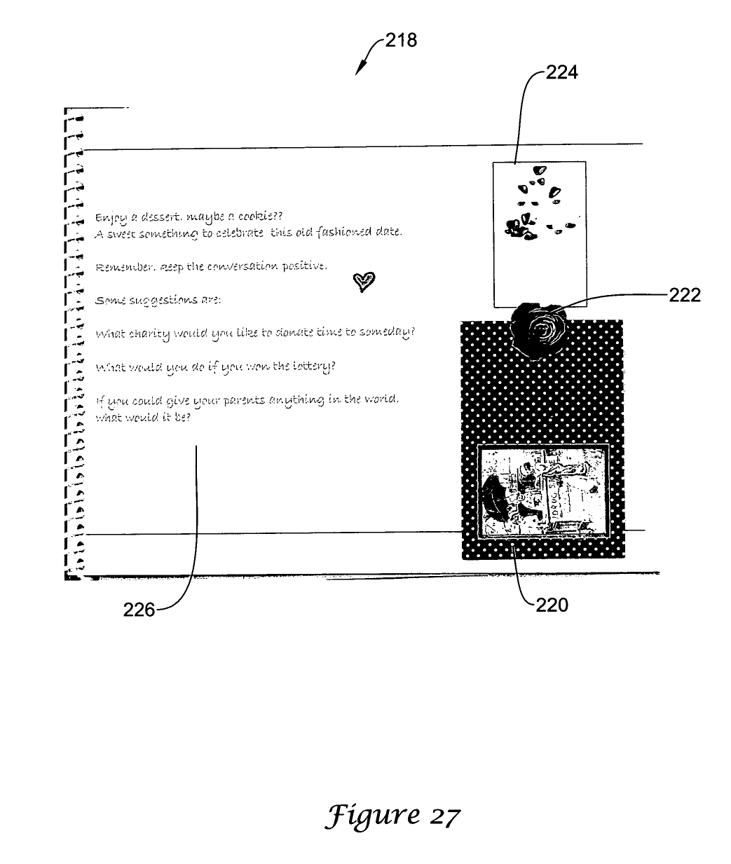

FIG. 27 shows a fifteenth page 218 having a pink background. Fifteenth page 218 includes an envelope 220 that is decorated with a black and white polka dot pattern as well as a small Normal Rockwell picture. Envelope 220 is closed with a rose sticker 222. A graphic 224 of an ice cream sundae is positioned above envelope 220. A text box 226 includes suggestions for discussion topics.

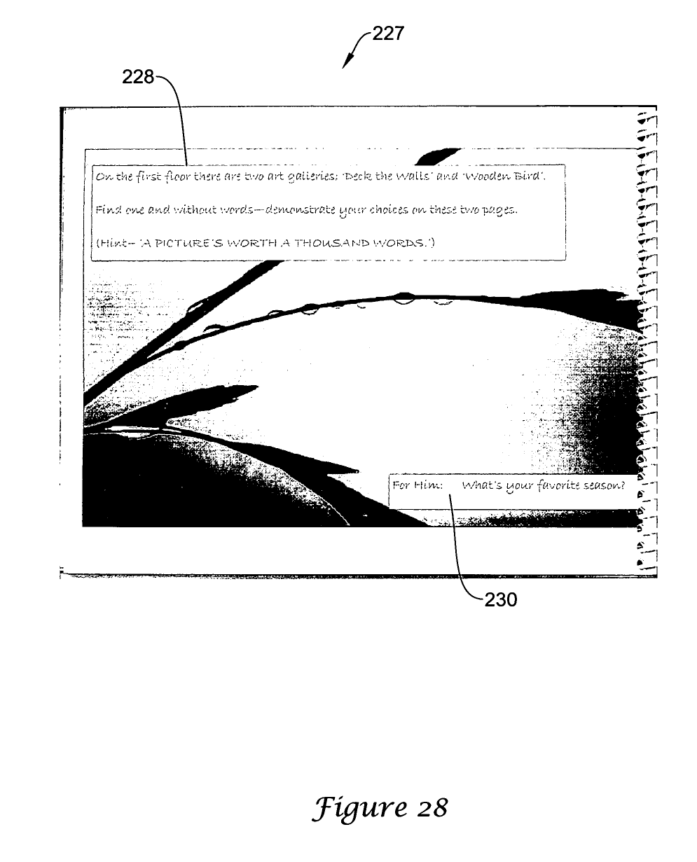

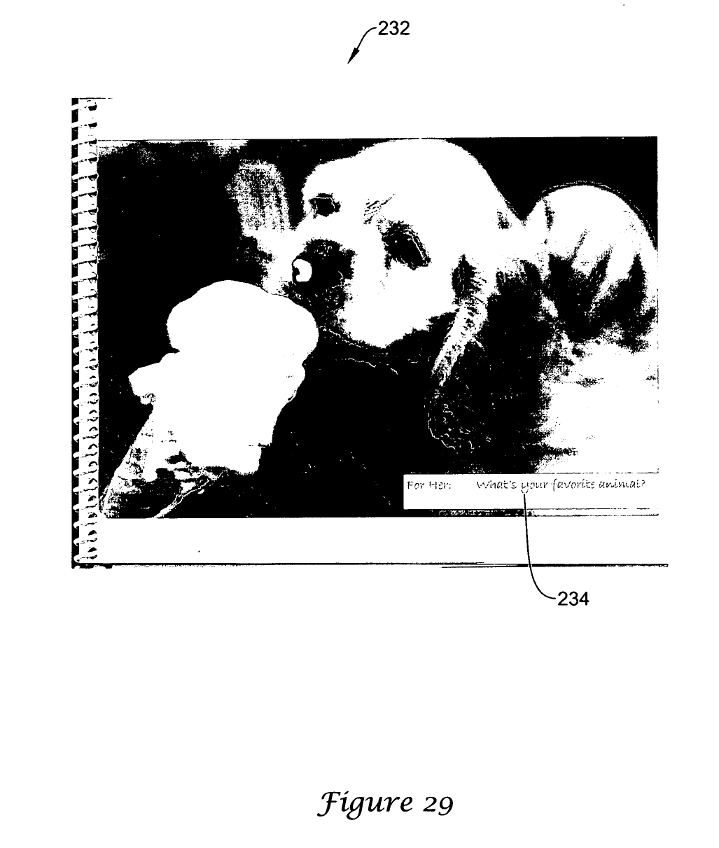

FIGS. 28 and 29 provide, in combination, activities for both the male and female participants, and involves several art galleries. FIG. 28 shows a sixteenth page 227, which may be considered as an opposite side to fifteenth page 218. A photo of a sunset is provided as the background to sixteenth page 227. A text box 228 provides instructions for FIG. 28 and FIG. 29. Another text box 230 instructs the male participant to find a painting in one of the art galleries that demonstrates his favorite season.

In FIG. 29, seventeenth page 232, bearing a photo of a child sharing an ice cream cone with a puppy as background, includes a text box 230 instructing the female participant to find a painting in one of the art galleries that shows her favorite animal.

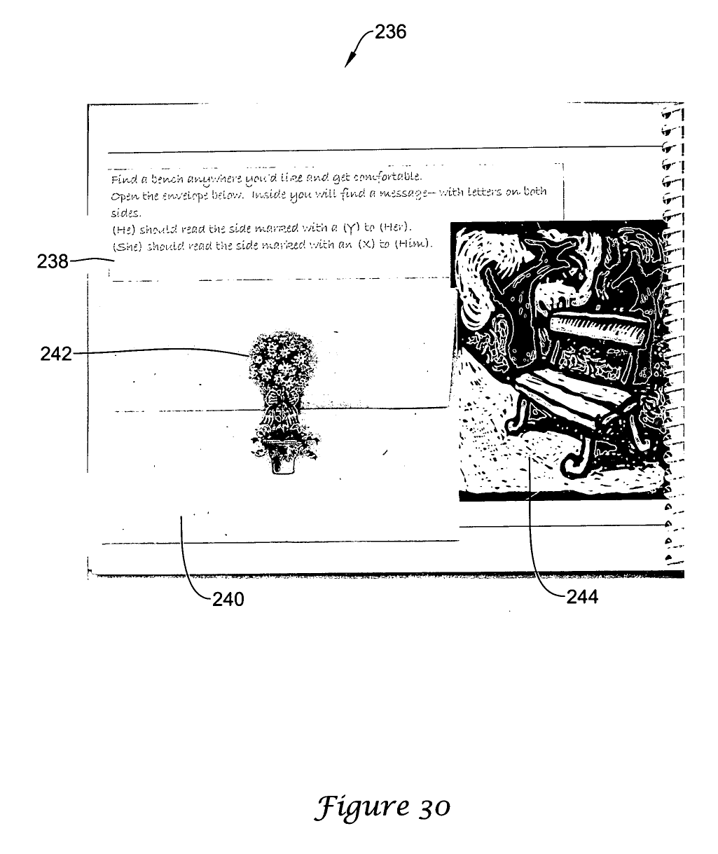

FIG. 30 shows an eighteenth page 236, which may be considered as an opposite side to seventeenth page 232 and which includes a spring green background. A text box 238 includes instructions to find a bench and open an envelope 240, which is sealed with a flower sticker 242. A graphic 244 of a park bench provides ambiance. Envelope 240 includes a piece of paper bearing reading assignments for both date participants. The male participant is instructed to read the side marked with a “Y” to the female participant, while the female participant is instructed to read the side marked with an “X” to the male participant. Each side provides a poem.

The poem marked with a “Y”, to be read to the female, is “Love's Philosophy”, by Percy Bysshe Shelley, and reads as follows:
‘The fountains mingle with the river,
and the rivers with the ocean;
The winds of heaven mix forever,
With a sweet emotion;
Nothing in the world is single;
All things by a law divine
In one another's being mingle;
Why not I with thine?
See! The mountains kiss high heaven,
And the waves clasp one another;
No sister flower would be forgiven,
If it disdained it's brother;
And the sunlight clasps the earth,
And the moonbeams kiss the sea;
What are all these kissings worth,
If thou kiss not me?’

The poem marked with an “X” , to be read to the male, is “Wild Nights”, by Emily Dickinson, and reads as follows:
‘Wild nights, Wild nights!
Were I with thee,
Wild nights should be
Our luxury!
Futile the winds
To a heart in port
Done with the compass
Done with the chart.
Rowing in Eden.
Ah, the sea.
Might I be moor
Tonight with thee!’

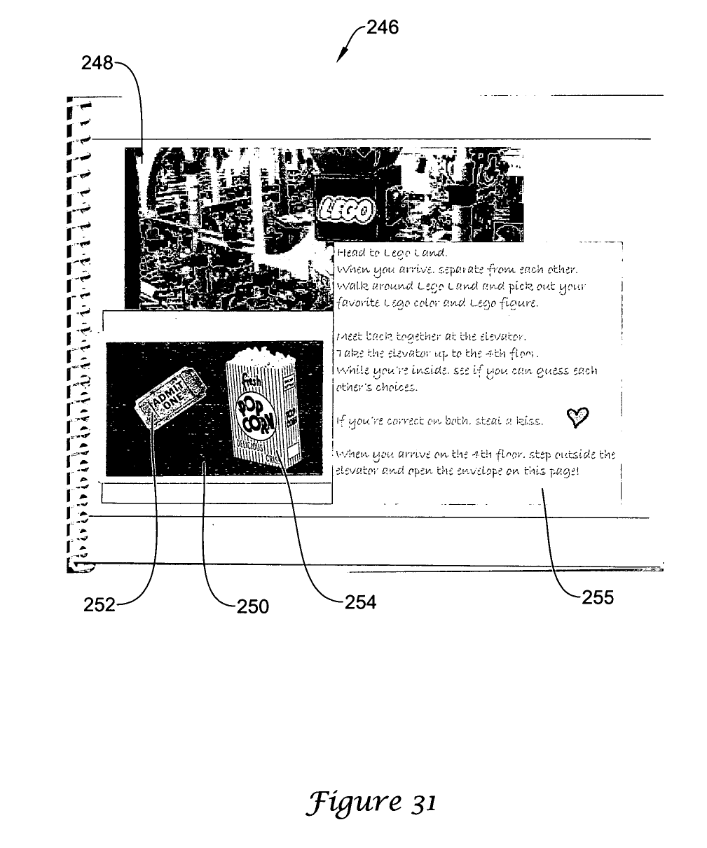

FIG. 31 shows a nineteenth page 246 having a spring green background. A photo 248 of Lego™ Land is provided in the background. An envelope 250, which is sealed with an Admit One sticker 252 and a popcorn sticker 254, contains movie tickets. A text box 255 includes instructions for each participant to separate, individually select their own favorite Lego color and Lego figure, and to meet together at the elevator. While on the elevator to the fourth floor, the participants may attempt to guess each other's favorites.

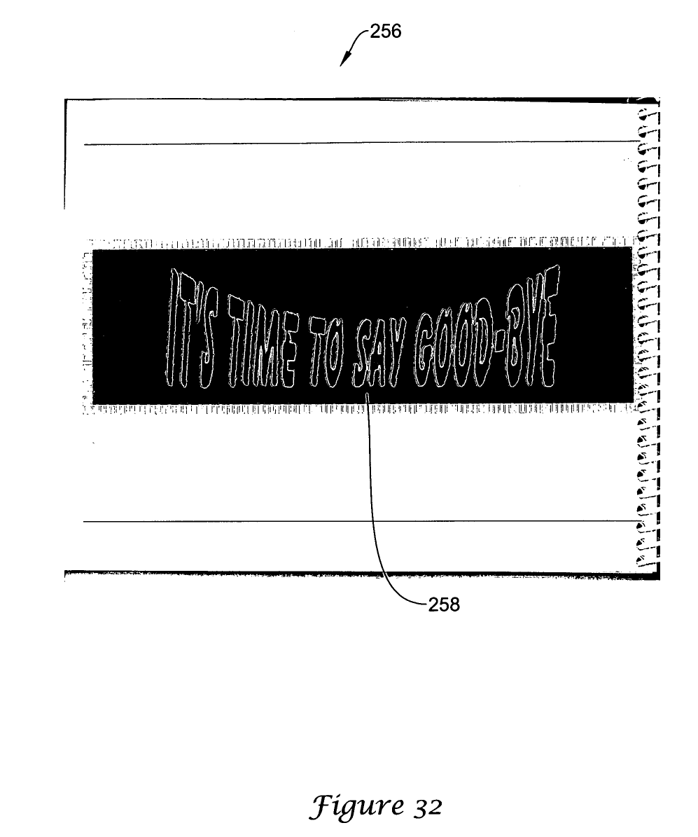

FIG. 32 shows a twentieth page 256 having a gray background, and which may be considered as an opposite side to nineteenth page 246. Twentieth page 256 simply includes a banner 258 announcing the end of the date.

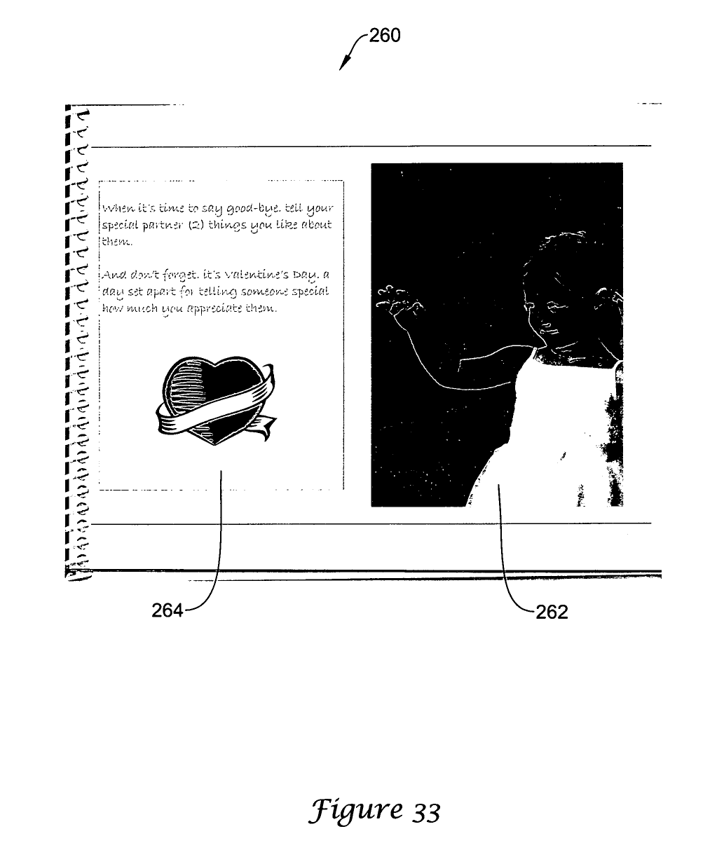

FIG. 33 shows a twenty-first page 260 having a gray background, and including a photo 262 of a girl waving good-bye. A text box 264 includes parting instructions for the participants.

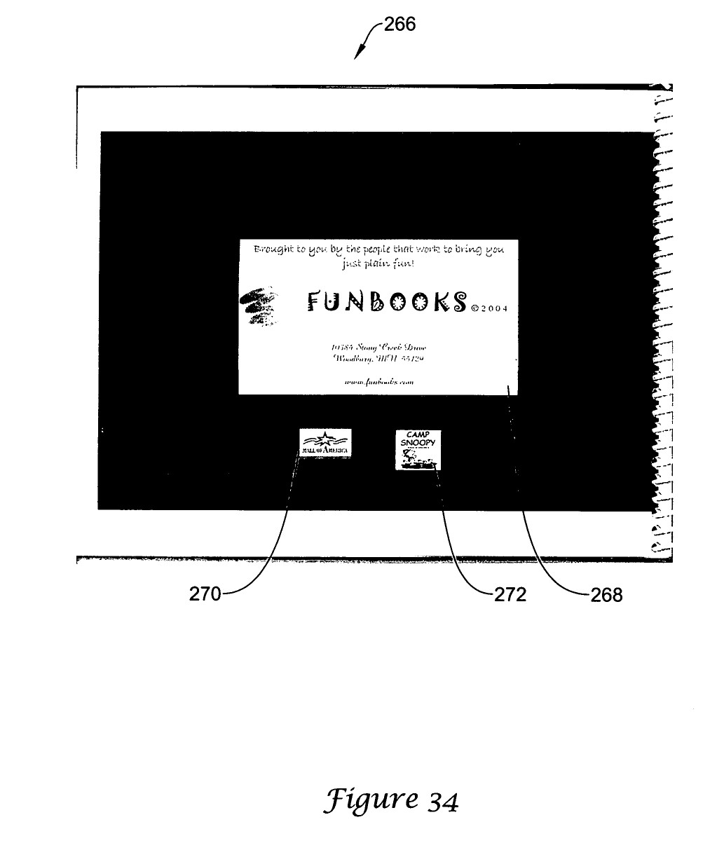

FIG. 34 shows a twenty-second page 266 having a deep blue background. Twenty-second page 266 may be considered as an opposite side to twenty-first page 260. Twenty-second page 266 includes a text box 268 stating who provided the Valentine's Day Date Book, a Mall of America™ logo 270 and a Camp Snoopy™ logo 272, both of which indicate sponsorship of, or participation in, the Valentine's Day Date Book. While not illustrated, the Valentine's Day Date Book includes a red leather paper back cover.

### EXAMPLE B

### “Minnesota State Fair Activity Book on a Stick”

The illustrative Minnesota State Fair Activity Book on a Stick is 5×5½″, and is bound by plastic cording on the top. High grade of 44 lb glossy paper was used. The cover may be customized for each individual or group, as desired. The back may be designed specifically for advertisement, if desired. Each page may be completed with appropriate envelopes and/or surprises, instructions or activities, as desired. These envelopes may be affixed in a variety of ways, such as; glue, string, ribbon, grommets or corner picture holders.

In the illustrative embodiment, the last two pages are glued onto a stick to provide the user with a holder for the activity book, resulting in an activity book on a stick. Other attachment mechanisms may also be used to attached the activity book to the stick, and other holders may be used other than a stick such as, for example, a plastic ring or any other suitable handle, as desired. Each page of the illustrative “Minnesota State Fair Activity Book on a Stick” will now be described.

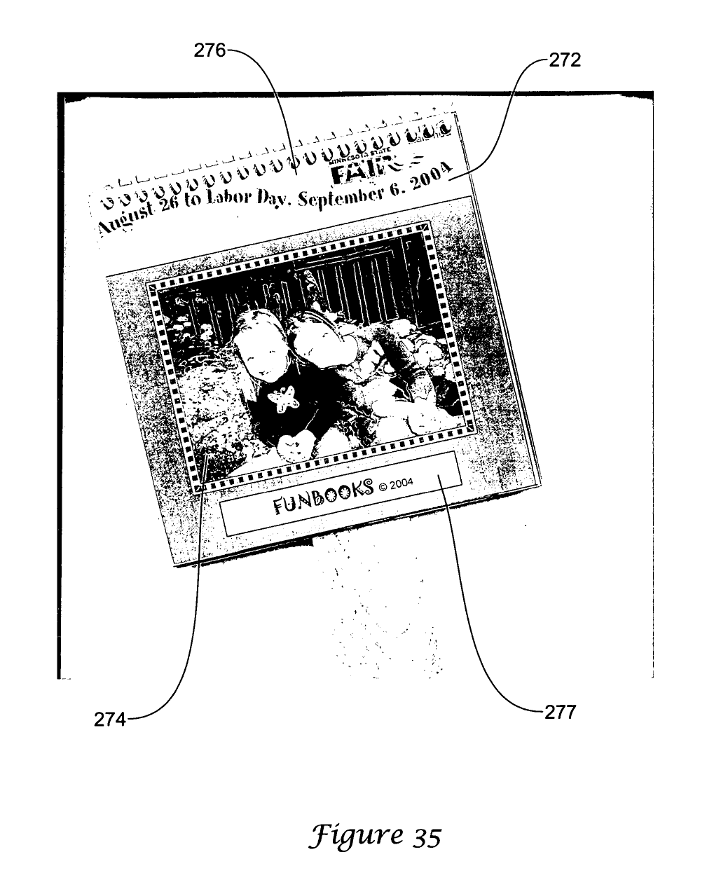

FIG. 35 shows a cover page 272 that is configured to accommodate a commemorative photo 274 that may be taken by the user at the State Fair. A logo 276 identifies the Minnesota State Fair while a text box 277 identifies the source of the activity book on a stick.

In some cases, cover page 272 may provide a custom book for individuals or groups, and may be a keepsake for fairgoers. It may also create an incentive for purchasing next year's activity book. The theme of the illustrative State Fair activity book is not centered on any specific thought—however, theme activity books for the Fair may also be used, if desired. Some illustrative themed activity books may include: an activity book dedicated to animals at the Fair; an activity book dedicated for children under the age of 10 at the Fair; an activity book dedicated to bizarre happenings or events at the Fair, etc.

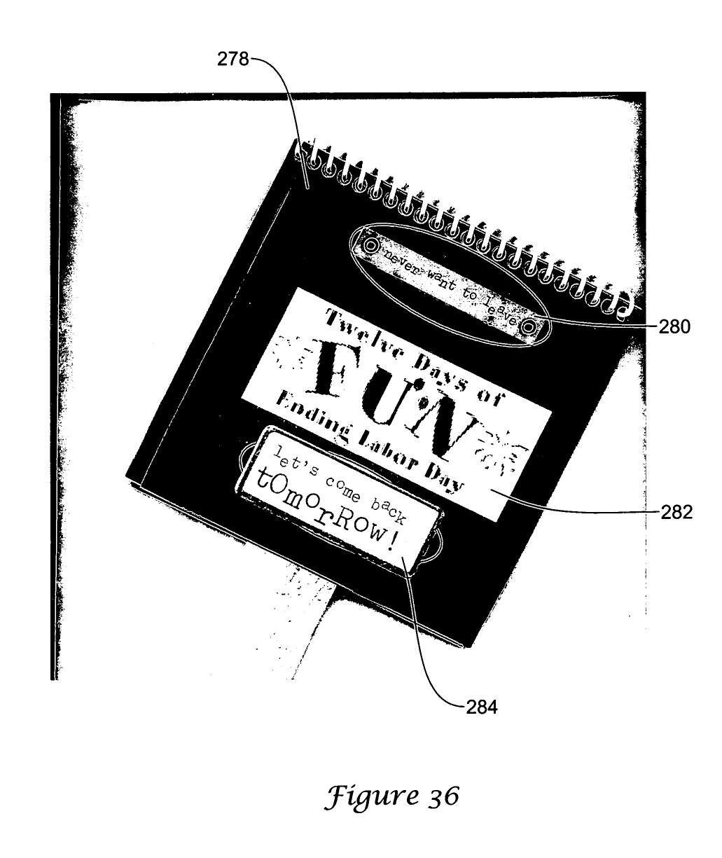

FIG. 36 shows a second page 278, which may be glued to the back of cover page 272. Second page 278 is created to provide promotions about the Fair—space may be sold to booths or organizations to advertise their products at the Fair. This page is a good example of an activity book that can be dedicated to vendors. Every page may be highlighting a particular paid sponsor. While no sponsors are shown on second page 278, graphics 280, 282 and 284 each show where a sponsor may have identifying text and graphics.

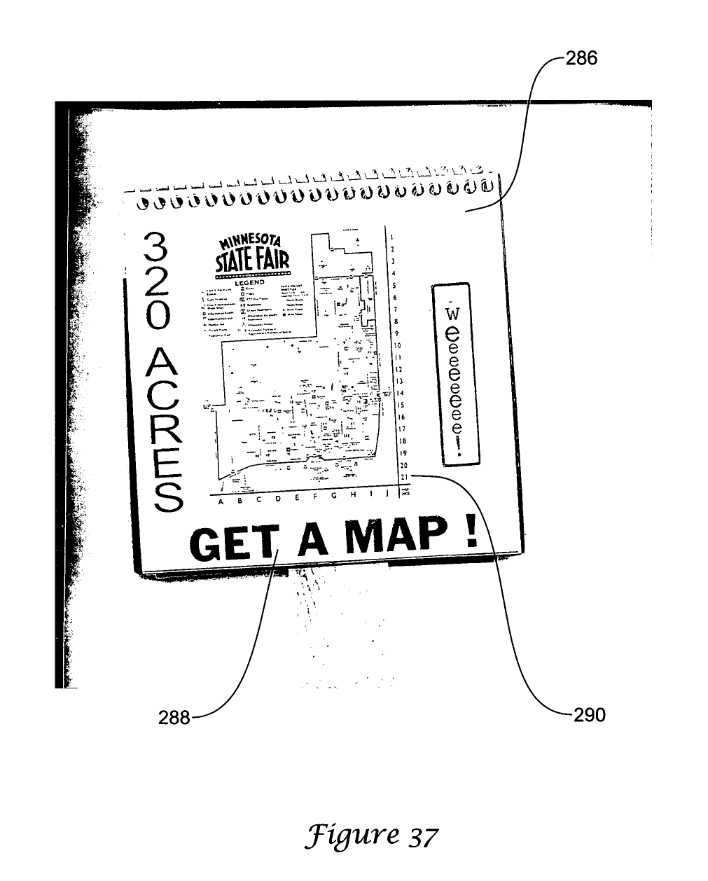

FIG. 37 shows a third page 286, which includes a suggestion 288 to get a map of the grounds and in fact includes a small map 290. Whether the user knows the layout of the Minnesota State Fair or not, this is a helpful little tool to assist the user in getting around at the Fair. Additional attributes to this page may include a map in a pocket or envelope attached to this page. In the illustrative embodiment, color is used on every two pages to provide consistency.

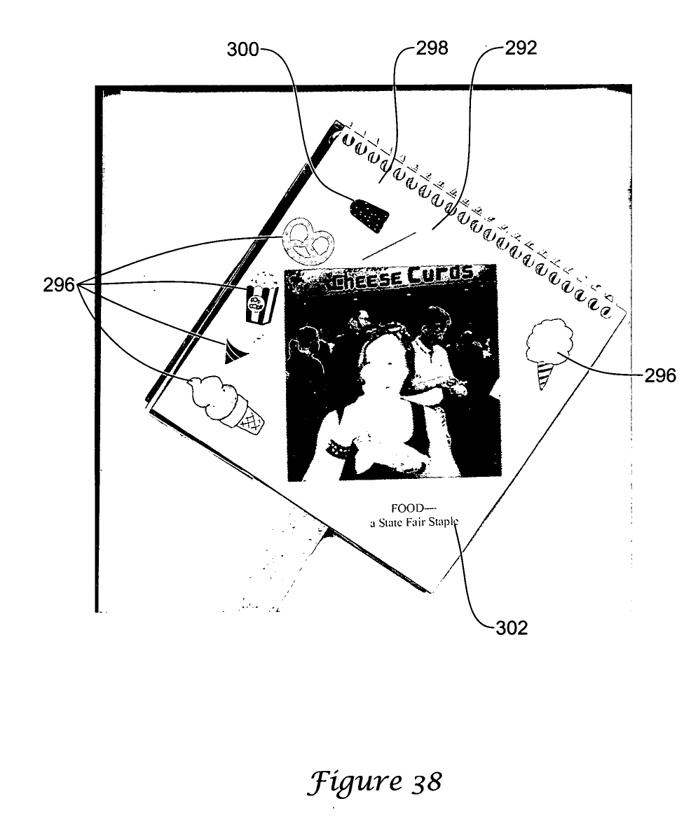

FIG. 38 shows a fourth page 292, which may be glued to the back of third page 286. Fourth page 292 includes a photo 294 of someone eating, and includes a number of icons 296 providing graphical suggestions of food available at the fair. Each of the icons 296 may be scratched to see if the user has won another activity or perhaps a food item at the fair. Fourth page 292 includes an envelope 298 sealed with an ice cream sticker 300. Envelope 298 may, for example, include a ticket for an ice cream treat. Fourth page 292 also includes a text box 302 reminding the user that food is, indeed, a primary purpose of attending the fair.

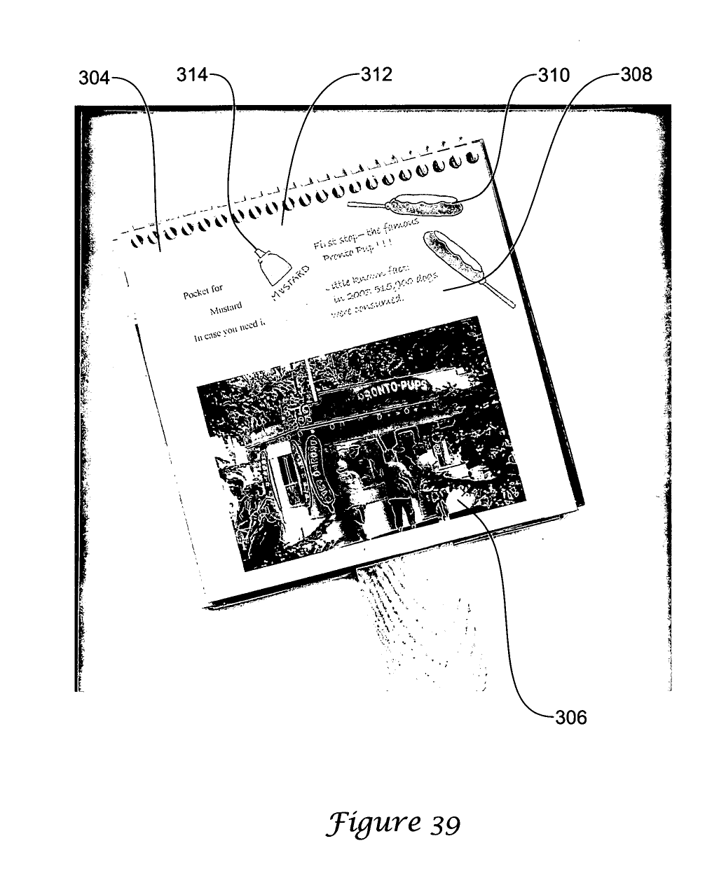

FIG. 39 shows a fifth page 304 that is dedicated to the Pronto-Pup. Fifth page 304 includes a photo 306 of a Pronto-Pup stand, a text box 308 providing little-known facts about the pronto-pup (corn dog) as well as a pronto-pup graphic 310. An envelope 312 sealed with a mustard sticker 314 may contain a coupon for a free pronto-pup or may instead contain a mustard packet.

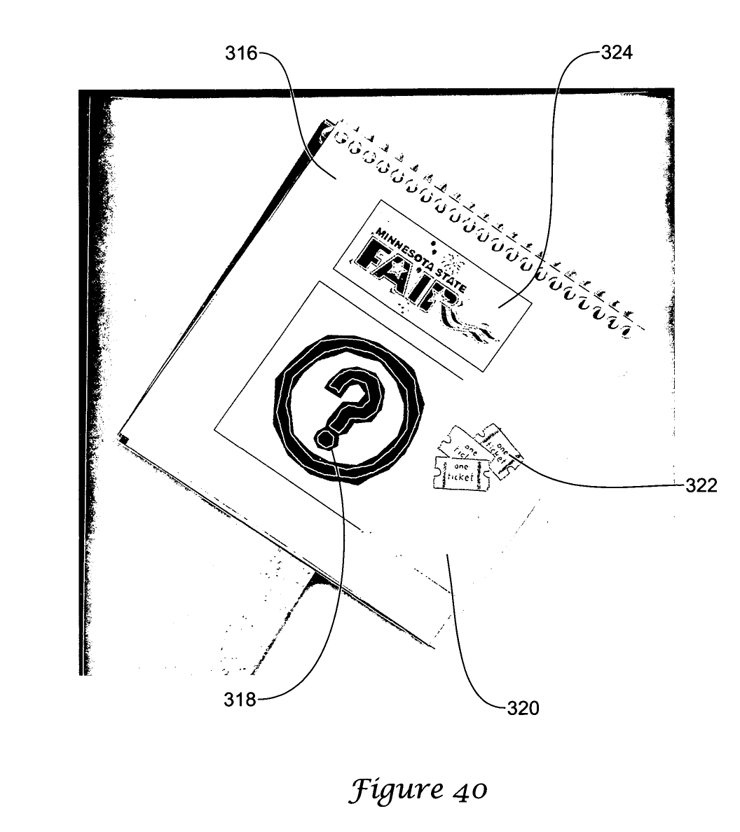

FIG. 40 shows a sixth page 316 that is glued to the back of fifth page 304. Sixth page 316 includes a surprise graphic 318, indicating that this page is a surprise. An envelope 320, sealed with a ticket sticker 322, may contain any number of items. For example, envelope 320 may include a free pass to a ride, fun money to be used anywhere at the fair, tickets for a Grandstand musical performance, or the like. A state fair logo 324 reminds the user where they are.

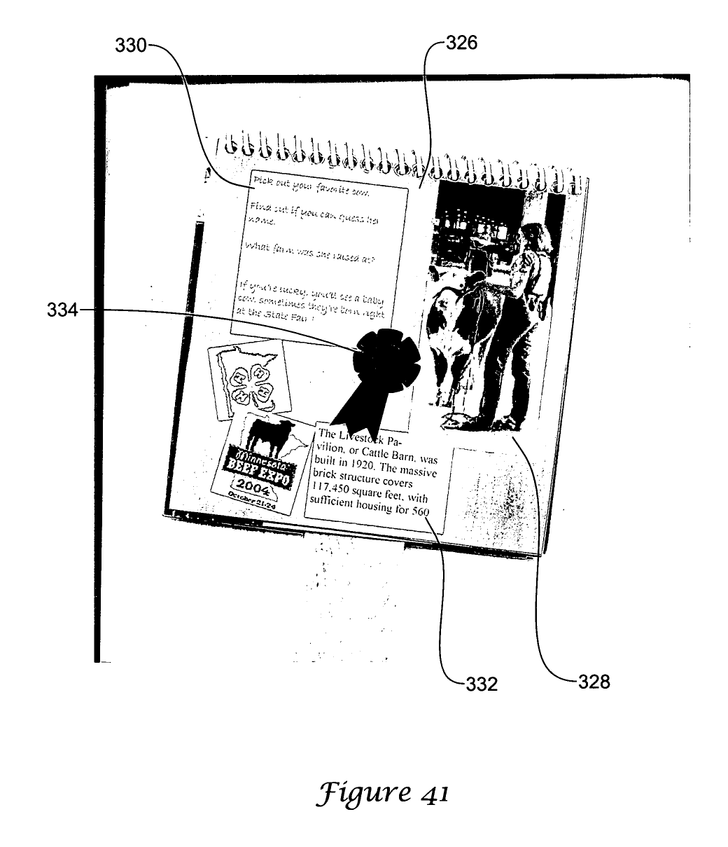

FIG. 41 shows a seventh page 326 that is designed to take the user to the Cattle Barn at the Fair. Seventh page 326 includes a photo 328, a text box 330 providing suggested activities as well as a text box 332 providing historical information regarding the Cattle Barn. A peel-off blue ribbon 334 is also provided. If the user presents peel-off blue ribbon 334 to a farmer in the Cow Barn, they receive the option of having his/her picture taken with the farmer's cow. The option may be pre-negotiated with the farmers at the Fair.

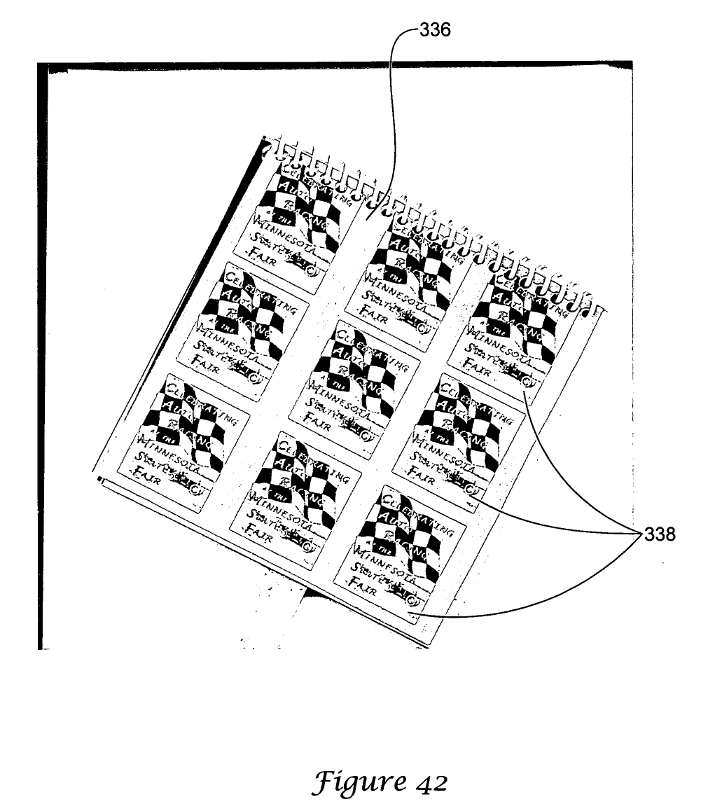

FIG. 42 shows an eighth page 336 that is glued to the back of seventh page 326. Eighth page 336 includes a total of nine scratch-offs 338. If a user wins by correctly guessing which scratch-offs 338 to remove, they may be instructed on where to pick up a free pass to the races. It should be recognized, however, that eighth page 336 could also be designed for many different promotional activities at the Fair.

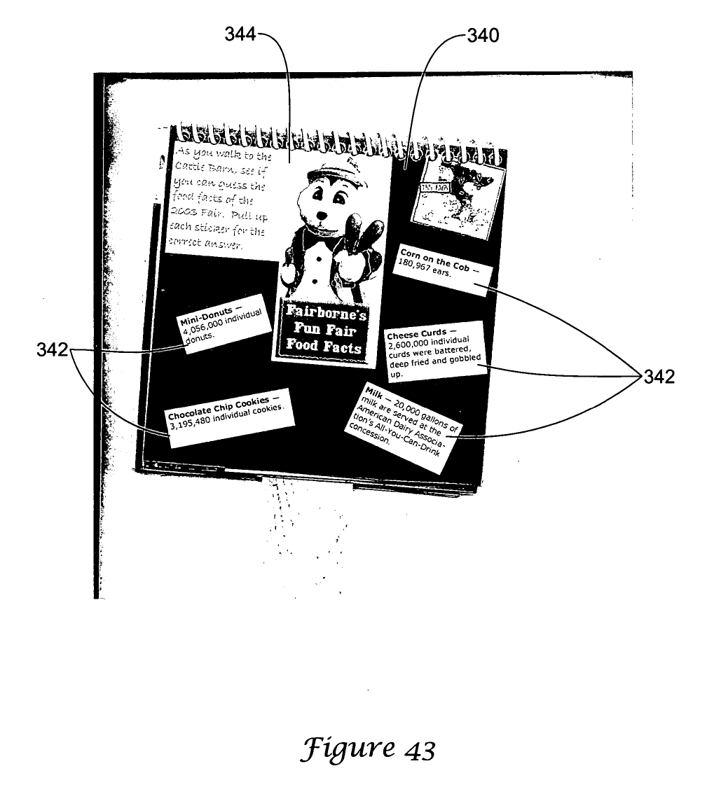

FIG. 43 shows a ninth page 340 that is designed for fun and to spark conversation. Ninth page 340 can be seen as including a number of correct answers 342 to various food trivia questions, as outlined in text box 344. While not shown in FIG. 43, it is considered that removable stickers would be positioned over each of the correct answers 342, so that a user would be encouraged to arrive at their own answer before looking it up.

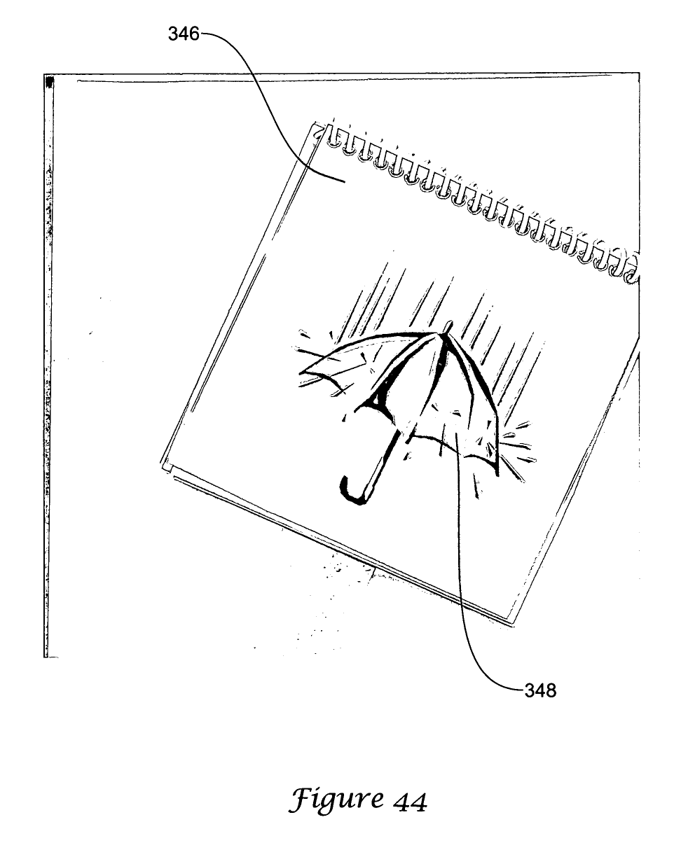

FIG. 44 shows a tenth page 346 that is glued to the back of ninth page 340. An umbrella 348 hides a small plastic head cover that can be used if it starts to rain.

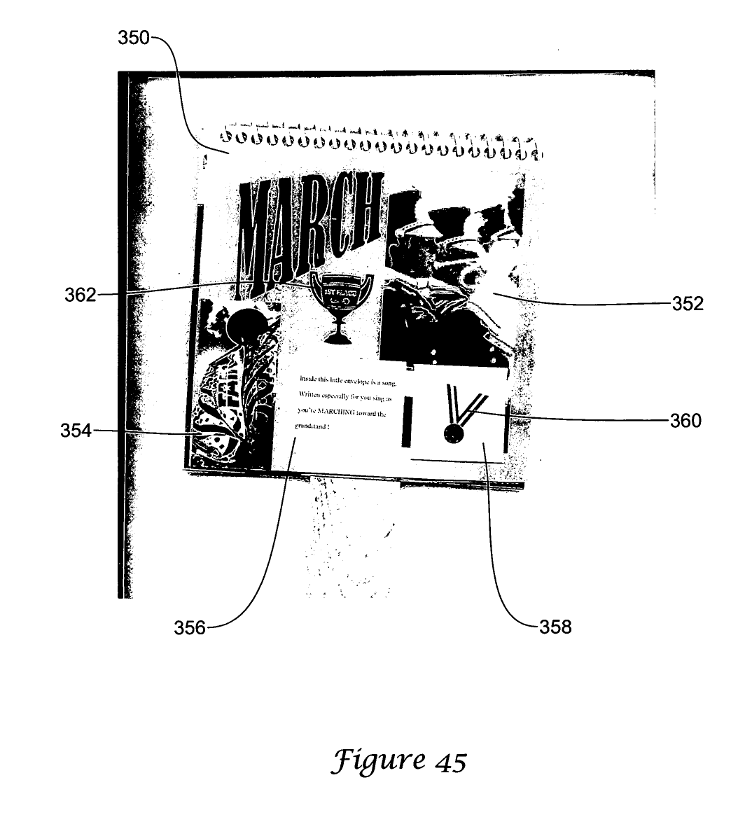

FIG. 45 shows an eleventh page 350 designed to send the user to the Grandstand. Eleventh page 350 includes a photo 352 and a photo 354. Text box 356 instructs the user to open envelope 358, which is sealed with a sticker 360. Inside envelope 358 are lyrics to a song which the user is encouraged to sing. Silver trophy 362 will, if pressed, provide music to support the user's song via a smart tag (not visible) provided underneath silver trophy 362.

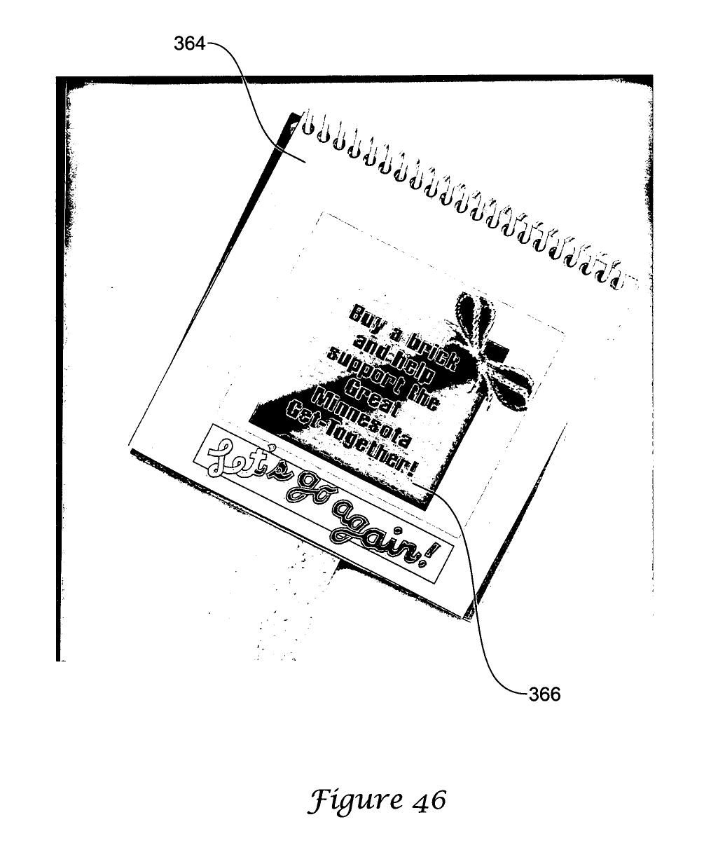

FIG. 46 shows a twelfth page 364, which is glued to the back of eleventh page 350. Twelfth page 364 is a promotional page which, in the illustrated case, is promoting a MN State Fair fundraising opportunity, via graphics 366.

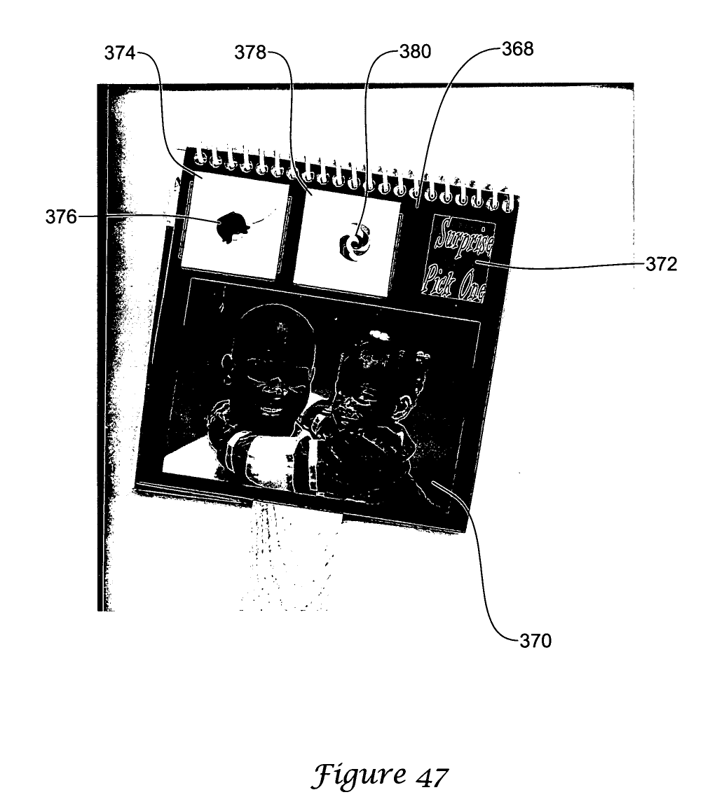

FIG. 47 shows a thirteenth page 368, which is a surprise page. A photo 370, which can either be a customized photo or a stock photo, is provided on or in thirteenth page 368. A graphic 372 instructs the user to pick either envelope 374, which is sealed by caramel apple sticker 376, or envelope 378, which is sealed by lollipop sticker 380. Any number of surprises may be contained inside envelope 374 and envelope 378. Examples include a coupon providing the user with a discount at a booth, or perhaps a discount on admission for a subsequent visit to the Fair.

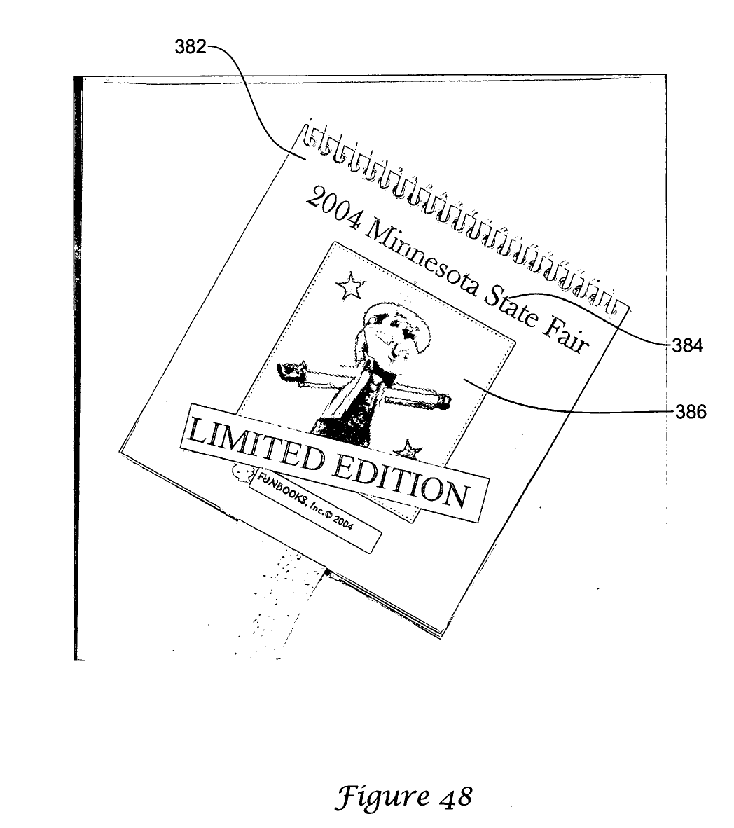

FIG. 48 shows a fourteenth page 382, which is glued to the back of thirteenth page 368 and which supports the stick. In the illustrated example, fourteenth page 382, which is also the back cover, is intended for promotional use, and as such space on fourteenth page 382 could be sold for advertising. As shown, fourteenth page 382 includes several logos and graphics 384 and 386 identifying the State Fair. In some cases, the activity books for each year may be unique, and thus may be considered limited editions.

The invention should not be considered limited to the particular examples described above, but rather should be understood to cover all aspects of the invention as set out in the attached claims. Various modifications, equivalent processes, as well as numerous structures to which the invention can be applicable will be readily apparent to those of skill in the art upon review of the instant specification.

What is claimed is:

1. An activity book comprising:
one or more pages directing a user through one or more predetermined activities; and
one or more accompaniments related to the predetermined activities.

2. The activity book of claim 1, designed for use at a particular location.

3. The activity book of claim 1, designed for use during a particular event.

4. The activity book of claim 1, designed for use at one or more particular destinations.

5. The activity book of claim 1, wherein the one or more accompaniments are secured relative to the one or more pages.

6. The activity book of claim 1, wherein the one or more accompaniments are disposed within an enclosure secured relative to the one or more pages.

7. The activity book of claim 6, wherein the enclosure comprises an envelope that is held in a closed position by a sticker.

8. The activity book of claim 6, wherein the enclosure comprises an envelope that is held in a closed position by wax.

9. The activity book of claim 6, wherein the enclosure comprises an envelope that is held in a closed position by a ribbon or a string.

10. The activity book of claim 1, wherein the one or more accompaniments comprise means for enhancing the one or more predetermined activities.

11. The activity book of claim 1, wherein one of the predetermined activities requires an entrance fee, and one of the one or more accompaniments comprises a ticket or coupon satisfying the entrance fee.

12. The activity book of claim 1, wherein the one or more accompaniments have entertainment value.

13. The activity book of claim 12, wherein the one or more accompaniments comprise at least one of a poem, a song, or a game.

14. The activity book of claim 1, wherein the one or more accompaniments comprise a device that is configured to, when activated, either play a prerecorded message or record a message.

15. The activity book of claim 1, wherein the one or more accompaniments have whimsical value.

16. The activity book of claim 1, wherein the one or more predetermined activities are configured to facilitate a date between two people using the activity book.

17. The activity book of claim 1, wherein the one or more predetermined activities are configured to facilitate achieving a goal.

18. The activity book of claim 17, wherein the goal comprises one of a corporate goal or a personal goal.

19. The activity book of claim 1, wherein the one or more predetermined activities are configured to celebrate an event.

20. The activity book of claim 19, wherein the event is a holiday.

21. The activity book of claim 19, wherein the event is a sponsored event.

22. The activity book of claim 1, comprising a front cover, a back cover and the one or more pages disposed between the front cover and the back cover.

23. The activity book of claim 1, further comprising a stick secured to the activity book such that the stick functions as a handle.

24. The activity book of claim 1, wherein the one or more pages comprise electronic pages.

25. The activity book of claim 24, wherein the one or more accompaniments comprise E-tickets.

26. The activity book of claim 3, wherein the one or more predetermined activities are designed to increase a user's knowledge of the particular location.

27. The activity book of claim 4, wherein the one or more predetermined activities are designed to increase a user's knowledge of the particular event.

28. The activity book of claim 5, wherein the one or more predetermined activities are designed to increase a user's knowledge of the particular destinations.

29. A series of activity books comprising at least a first activity book and a second activity book intended for use subsequent to use of the first activity book;
the first activity book comprising:
one or more pages directing a user through one or more predetermined activities; and
one or more accompaniments related to the predetermined activities; and
the second activity book comprising:
one or more pages directing a user through one or more predetermined activities; and
one or more accompaniments related to the predetermined activities.

30. A fun book comprising:
a first page comprising instructions to engage in a first activity;
means to facilitate the first activity secured relative to the first page;
a second page comprising instructions to engage in a second activity subsequent to the first activity; and
means to facilitate the second activity secured relative to the second page.

31. An exploration book, the exploration book configured to facilitate exploration of a predetermined location, the exploration book comprising:
a first page comprising instructions to engage in a first activity at a first locale within the predetermined location;
means to facilitate the first activity secured relative to the first page;
a second page comprising instructions to engage in a second activity at a second locale within the predetermined location; and
means to facilitate the second activity secured relative to the second page.

32. An event book, comprising:
a first page comprising instructions to engage in a first activity at the event;
means to facilitate the first activity secured relative to the first page;
a second page comprising instructions to engage in a subsequent second activity at the event; and
means to facilitate the second activity secured relative to the second page.

33. A date book for use by two individuals, the date book comprising:
a first page comprising instructions to engage in a first activity;
means to facilitate the first activity secured relative to the first page;
a second page comprising instructions to engage in a subsequent activity; and
means to facilitate the subsequent activity secured relative to the second page.

34. An apparatus comprising:
a stick; and
a book secured relative to the stick, wherein the stick extends out from the book and provides a handle for the book.

35. The apparatus of claim 34, wherein the book is an activity book that includes two or more pages, wherein at least selected pages lead a user through one or more activities at a particular location.

36. A book comprising:
a cover, a back and two or more pages between the cover and the back; and
a handle secured relative to the cover, back and/or the two or more pages.

37. The book of claim 36, wherein the book is an activity book, wherein at least selected pages lead a user through one or more activities at a particular location.
